(19) United States
(12) Patent Application Publication
(10) Pub. No.: US 2019/0096274 A1
(43) Pub. Date: Mar. 28, 2019

(54) EDUCATIONAL TEACHING METHODS AND SYSTEMS PROVIDING GAMES AND LESSONS FOR MEASURING PROPERTIES OF VIRTUAL OBJECTS UTILIZING VIRTUAL MEASUREMENT INSTRUMENTS

(71) Applicant: TheBeamer LLC, East Hartford, CT (US)

(72) Inventors: Peter Solomon, West Hartford, CT (US); Patrick Belanger, Ashford, CT (US); Kenneth Thompson, Manchester, CT (US)

(73) Assignee: TheBeamer LLC, East Hartford, CT (US)

(21) Appl. No.: 16/124,523

(22) Filed: Sep. 7, 2018

Related U.S. Application Data
(60) Provisional application No. 62/555,211, filed on Sep. 7, 2017.
(60) Provisional application No. 62/566,703, filed on Oct. 2, 2017.

(51) Int. Cl. G09B 7/08

(52) U.S. Cl. CPC G09B 7/08; G06F 3/04847

(57) ABSTRACT

The objects of the present invention are to provide technology for facilitating the teaching of subjects using virtual 3-D scenes or environments (such as used in video games or VR displays) in which objects in the virtual scene can have their properties identified using virtual measurement instruments. Each important object or section of an object in the virtual world would have a file of its properties and each virtual measurement instrument would have instructions for how to display them. The object's properties can, thus, be displayed by identifying a virtual instrument and then identifying the object or section of the object, by for example, pointing with a mouse curser and clicking a mouse button. Measurement instruments could be created for displaying an object's chemical composition, weight, temperature, chemical compound makeup, hardness, thermal decomposition temperature, radiation emissions or reflections, odor, electric field, magnetic field, gravitational field, nuclear force, color, size, age, molecular structure, chemical activity, DNA analysis, atomic inheritance probability counter, radioactive rock dating, carbon dating, X-ray image, CAT scan, image analysis, microscopic view, gas chromatograph, mass spectrometer, infrared spectrometer, visible spectrometer, breath analysis, blood analysis, drug screen, blood pressure, pulse rate, fingerprints on the surface, surface image for hair matching or firearm identification, and other physical and chemical properties. Lessons on subjects can be created by specifying a sequence of objects to be measured, the measurements to be made, the data to be recorded, together with questions about the data and conclusions that can be drawn. Standard lessons can be created by subject matter experts or customized lessons can be created by the teachers of the subject.

### CROSS REFERENCE TO RELATED APPLICATIONS

This application claims the benefit under 35 U.S.C. § 119(e) of U.S. Provisional Application No. 62/555,211 filed on Sep. 7, 2017 and U.S. Provisional Application No. 62/566,703 filed on Oct. 2, 2017, which are hereby incorporated by reference in their entirety.

U.S. application Ser. No. 14/756,737 filed on Oct. 7, 2015 and titled “EDUCATIONAL SYSTEM OR TEACHING SCIENCE, HISTORY AND OTHER SUBJECTS” and U.S. application Ser. No. 15/409,718 filed on Jan. 19, 2017 and titled “EDUCATIONAL TEACHING SYSTEM AND METHOD UTILIZING INTERACTIVE AVATARS WITH LEARNING MANAGER AND AUTHORING MANAGER FUNCTIONS” are hereby incorporated by reference in their entirety.

This invention was made with government support under Award Number 1549522 from the National Science Foundation's Division of Industrial Innovation & Partnership. The U.S. government has certain rights in the invention.

### TECHNICAL FIELD

The present application is directed to education and learning tools, providing individualized learning experiences using stories and games.

### BACKGROUND

A need exists for effective and engaging educational tools for education in general, and more particularly, to support the teaching of academic subjects such as science, art and history, and to provide career related training for military, police, medical and fire personnel. The need is critical in grades k-12 where there is a shortage of certified science teachers. Since over 90% of grades 3-12 students play video games, this medium has received attention for the creation of learning products. Studies have demonstrated that game-based learning has significant benefits compared to non-game learning. Game-based learning products have achieved the fastest growth among comparable learning product types.

### SUMMARY

In accordance with one aspect of the present invention, provided is technology for facilitating the teaching of subjects using virtual 3-D scenes or environments (such as used in video games) in which objects or organisms in the virtual scene can have their properties identified using virtual measurement instruments. An object or organism's properties can be displayed by selecting a virtual instrument and then identifying the object/organism or section of the object/organism to be examined. For example, consider a virtual scene including a body of water, where a user can select a virtual instrument for detecting the material composition of the body of water. The virtual scene may be adapted so that the user can point and select the virtual body of water for measurement by, for example, moving a mouse cursor over the body of water and clicking on the body of water. The virtual instrument could then show that the virtual body of water has a composition of oxygen and hydrogen in percentages representative of water. Similar measurement instruments could be created for displaying various types of object/organism properties, including weight, temperature, chemical compound makeup, hardness, thermal decomposition temperature, radiation emissions or reflections, odor, electric field, magnetic field, gravitational field, nuclear force, color, size, age, molecular structure, chemical activity, DNA analysis, atomic inheritance probability counter, X-ray image, CAT scan, image analysis, microscopic view, gas chromatograph, mass spectrometer, infrared spectrometer, visible spectrometer, breath analysis, blood analysis, drug screen, blood pressure, pulse rate, fingerprints on the surface, surface image for hair matching or firearm identification, and other physical and chemical properties or other information.

In accordance with another aspect of the invention, provided is a computer system for providing digital games and lessons utilizing virtual measurement instruments and virtual objects. In one embodiment, the system comprises one or more physical computer processors executing a plurality of components, including an environment component, an instrument component, and an object component. The environment component executes an instance of a computer game to one or more users via one or more user computer devices. The computer game comprises a virtual scene, a plurality of virtual objects, and a plurality of virtual measurement instruments. Also, the computer game comprises an interface for user inputs for controlling in-game actions, including selection of virtual objects and virtual measurement instruments. The instrument component comprises a library of the virtual measurement instruments available in the computer game, and graphically presents, to the user via the user computer device, a user-selected virtual measurement instrument. The object component comprises a database of the virtual objects available in the computer game and data regarding various properties of the virtual objects, and graphically presents, to the user via the user computer device, data associated with a user-selected property of a virtual object and the user selected virtual measurement instrument.

In some embodiments, the one or more processors of the system further execute a lesson component that graphically presents, to the user via the user computer device, a player objective sequence that indicates a set of virtual objects to be analyzed by the user using one or more virtual measurement instruments. Further, in some embodiments, the lesson component graphically presents, to the user via the user computer device, a worksheet providing tables for the user to enter data and prompts to the user to answer questions regarding the player objective sequence.

Additionally, in some embodiments, the system further comprises a secondary computer device in communication with the one or more processors. The secondary computer device executes a software application for simulating and displaying the user selected virtual measurement instrument on the secondary computer device. Further, the secondary computer device executes the software application and communicates with the instrument component so that use of the measurement instrument presented on the secondary computer device is coordinated with the play of the computer game on the user computer device.

Additionally in some embodiments, the one or more processors of the system provide an interface for use by the teacher or other lesson facilitator with templates to facilitate the creation of customized lessons comprising the player objective sequences to be displayed for the player and the worksheets for the player to record data and answer questions.

In accordance with another aspect of the invention, provided is a computer-implemented method for providing digital games and lessons utilizing virtual measurement instruments and virtual objects. In one embodiment, the method comprises executing with one or more physical computer processors a plurality of components, including an environment component, an instrument component, and an object component. Executing the environment component to present an instance of a computer game to one or more users via one or more user computer devices. The computer game comprises a virtual scene, a plurality of virtual objects, and a plurality of virtual measurement instruments. Also, the computer game comprises an interface for user inputs for controlling in-game actions, including selection of virtual objects and virtual measurement instruments. Executing the instrument component to store a library of the virtual measurement instruments available in the computer game. And further executing the instrument component to graphically present, to the user via the user computer device, a user-selected virtual measurement instrument. Executing the object component to store a database of the virtual objects available in the computer game and data regarding various properties of the virtual objects. And further executing the object component to graphically present, to the user via the user computer device, data associated with a user-selected property of a virtual object and the user selected virtual measurement instrument.

In some embodiments, the method further comprises executing a lesson component to graphically present, to the user via the user computer device, a player objective sequence that indicates a set of virtual objects to be analyzed by the user using one or more virtual measurement instruments. Further, in some embodiments, the method further comprises executing the lesson component to graphically present, to the user via the user computer device, a worksheet providing tables for the user to enter data and prompts to the user to answer questions regarding the player objective sequence.

Additionally, in some embodiments, the method further comprises executing a software application on a secondary computer device in communication with the one or more processors for simulating and displaying the user selected virtual measurement instrument on the secondary computer device. And further executing the software application on the secondary computer device to communicate with the instrument component so that use of the measurement instrument presented on the secondary computer device is coordinated with the play of the computer game on the user computer device.

In another embodiment, the method comprises presenting a computer game to one or more users via one or more user computer devices, where the computer game includes a virtual scene, a plurality of virtual objects, and a plurality of virtual measurement instruments. The method also comprises presenting to the user(s) a player objective sequence that indicates a set of virtual objects to be analyzed by the user using one or more virtual measurement instruments. The method further comprises receiving user(s) input for a selected instrument, a selected object, and a selected object property, and presenting to the user(s) data corresponding to the selected instrument, object, and object property. The method additionally may comprise presenting to the user(s) a worksheet providing tables for the user(s) to enter data and prompts to the user(s) to answer questions regarding the player objective sequence.

Additionally in some embodiments of the method, the one or more computing devices provides an interface for a teacher or other facilitator of the lesson with templates to facilitate the creation of one or more customized lessons comprising the player objective sequences to be displayed for the player and the worksheets for the player to record data and answer questions.

In accordance with another aspect of the invention, provided is a computer-implemented method for providing customized digital games and lessons utilizing virtual measurement instruments and virtual objects. One or more physical computer processors execute an In-Game Editor component to generate an In-Game Editor Graphical User Interface (GUI) on a user computer device. The In-Game Editor GUI includes: a virtual scene; a library of different virtual environments; a library of different virtual objects; and a library of different virtual instruments. The In-Game Editor GUI is configured to receive user inputs to define a customized game, including: selection of one or more virtual environments; selection and placement of one or more virtual objects in the selected virtual environments; and selection of one or more virtual instruments associated with the selected virtual objects. The one or more physical computer processors store the selection of virtual environments, selection and placement of virtual objects in the selected virtual environments and selection of virtual instruments associated with the selected virtual objects for the customized game.

In some embodiments, the In-Game Editor GUI includes one or more avatars configured to be controlled by user inputs to make selections from the library of different virtual environments, library of different virtual objects, and library of different virtual instruments.

Also, in some embodiments, the In-Game Editor GUI is configured to receive user inputs for selecting one of the one or more avatars in the virtual scene to define a customized game for the selected avatar.

Further, in some embodiments, the one or more physical computer processors store the selection of virtual environments, selection and placement of virtual objects in the selected virtual environments and selection of virtual instruments associated with the selected virtual objects for the customized game for the selected avatar.

In some embodiments, the one or more physical computer processors execute a lesson component to graphically present a player objective sequence for the customized game that indicates the selected virtual environments to be explored, the selected virtual objects to be analyzed in the selected virtual environments, and the selected virtual instruments to be used to analyze the selected virtual objects.

In some embodiments, the one or more physical computer processors execute an environment component to provide the selected virtual environments in the customized game.

In some embodiments, the one or more physical computer processors execute an object component to provide the selected virtual objects in the customized game.

In some embodiments, the one or more physical computer processors execute an instrument component to provide the selected virtual instruments in the customized game.

In some embodiments, the In-Game Editor GUI includes a template for creating a worksheet providing tables for entering data and answering questions regarding a player objective sequence; and further comprising the step of: receiving user inputs in the template for creating the worksheet.

In accordance with another aspect of the invention, provided is a non-digital game for providing lessons regarding the measurement of objects' properties using different measurement instruments. The game comprises a set of physical representations of a plurality of scenes, a set of physical representations of a plurality of objects, a reference book listing various properties of the plurality of objects, and a plurality of worksheet templates. The physical representations of the scenes may be photographs, illustrations, dioramas, etc., which depict different environments and/or time periods. The physical representations of the objects may be figurines, miniature objects, photographs, illustrations, stickers, etc., which can be placed in association with a physical representation of a scene. Each object has a unique identifier that is visually presented thereon. The reference book lists the unique identifiers corresponding to the plurality of objects and various properties for each of the objects. The worksheet is configured to provide a player objective sequence that indicates a set of objects to be analyzed, prompts for the player to record data regarding the objects found in the reference book, and prompts for the player to answer questions regarding the various properties of the objects found in the reference book.

In accordance with another aspect of the invention, provided is a method of using a non-digital game or story for providing lessons regarding the measurement of objects' properties using different measurement instruments. The method comprises providing a physical representation of a scene, a plurality of physical representations of different objects in association with the physical representation of the scene, a reference book listing various properties of the objects, and a worksheet. Presenting a user with the worksheet, where the worksheet provides a player objective sequence that indicates a set of objects to be analyzed, prompts for the player to record data regarding properties of the objects found in the reference book, and prompts for the player to answer questions regarding the properties of the objects found in the reference book.

Additionally in some embodiments of the method, additional material is provided for a teacher or other facilitator of the lesson including templates to facilitate the creation of one or more customized lesson comprising the player objective sequences to be available for the player and the worksheets for the player to record data and answer questions.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIG. 1 shows an exemplary embodiment of a system for implementing the present invention;

FIG. 2 shows another exemplary embodiment of a system for implementing the present invention;

FIG. 3 is a generic illustration of an avatar interacting with a selected object in a virtual environment using a selected virtual measurement instrument;

FIG. 4 is an example of the presentation of a chemical composition and temperature measurement of an object;

FIG. 5 is an example of the presentation of the magnetic field of the earth displayed as a field diagram superimposed on the image of the earth;

FIG. 6 is an illustration of a virtual measurement Instrument that imposes the X-Ray image of the portion of the Object that has been selected;

FIG. 7 is an example of a probe that reports the probable number of carbons in the selected object that have been inherited, and are presently in the player or student;

FIG. 8 is an illustration of an alternative presentation of the inherited carbons as the number of inherited T-Rex carbons in each of the student's white blood cells;

FIG. 9 is an illustration of the Chemical Analysis from the Mission KT game showing the major elements in a parasaurolophus during the cretaceous period, which is selected by the locating the cross hairs (in the center of the picture) on the object and clicking the mouse button;

FIG. 10 is an illustration of presenting magnetic field direction in a compass in the lower right hand corner of Mission KT game, which allows players to find locations in the environment and one another during game play, and a virtual Digital Geiger counter insert in lower left that shows local radioactivity;

FIG. 11 is an example of an odor detector in the Mission KT game showing a scent trail as a green line superimposed on the environment and a Parasaurolophus clone that can follow the scent like a bloodhound would follow an odor trail;

FIG. 12 is an illustration of a virtual measurement instrument that presents the molecular compound analysis of a selected location as an image, enlarged to molecular scale, of the molecules present in that location;

FIG. 13 is an illustration of the path followed by carbon as it is taken in by plants as carbon dioxide and converted to sugars by photosynthesis with oxygen as a byproduct;

FIG. 14 is an Illustration showing how the carbon from the plant is now cycled to the new dinosaur as it eats the plant;

FIGS. 15A-15E show an exemplary worksheet;

FIGS. 16A-16C show an exemplary worksheet template that can be employed by the teacher or lesson instructor to facilitate the creation of customized lessons including player objective sequences, data entry and questions for the player to answer;

FIG. 17 is an example of a user interface for the selection from a library of scenes and environments;

FIG. 18 is an example of a map for a scene or environment selected from a library showing sectors where objects and organisms may be placed;

FIG. 19 is an example of the user interface to configure a game by selecting objects and organisms to be located in a sector of a scene or environment;

FIG. 20 is an example of a user interface for the library of objects whose properties may be displayed and edited;

FIG. 21 is an example of Object/Organism properties that may be associated with each object or organism;

FIG. 22 is an example of a user interface for a library of object/organism properties to be measured or activated by the virtual instruments or capabilities;

FIG. 23 is an example of a user interface for selecting instruments and capabilities for use by one of the game's avatars;

FIG. 24 is an illustration of an In-Game Editor for selecting objects/organisms to be placed in a scene or environment by the Game Author using any player Avatar;

FIG. 25 is an illustration of an In-Game Editor for selecting the instruments or capabilities available to each player Avatar selected by the Game Author using that player's Avatar;

FIG. 26 is an illustration of an In-Game Editor for selecting multiple scenes which can be linked to produce the configurable game;

FIG. 27 is an illustration of an In-Game Editor used for selecting multiple objects or organisms to be placed in the game scenes;

FIG. 28 is an illustration of an In-Game Editor used for selecting multiple tools or virtual instruments to assign to any one of player functions;

FIG. 29 is an illustration of a preferred embodiment of the invention in which a time, space, and size-change travel machine called the Cosmic Egg is employed both as an In-Game Editor to configure the custom game and as a feature of the game which links scenes of different places, dates in history and scene dimension from microscopic to cosmic sizes;

FIG. 30 is an illustration of a preferred embodiment of the invention presenting the Interior of the Cosmic Egg used as an In-Game Editor for the display and selection of the player functions and avatars used by the players in the completed game;

FIG. 31 is an illustration of a preferred embodiment of the invention presenting the Interior of the Cosmic Egg used as an In-Game Editor for the display and selection of the tools or virtual instruments to be employed in the completed game for use by the player functions.

FIG. 32 is an illustration of a preferred embodiment of the invention presenting the Interior of the Cosmic Egg used as an In-Game Editor for the display and selection of the of the objects and organisms that are to be placed in the completed game; and

FIG. 33 is an illustration of a preferred embodiment of the invention presenting the player's user interface resulting from a player using the “Analysis” tool on a dinosaur target to determine its elemental composition;

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

In accordance with one aspect of the present invention, the present application provides educational systems and methods utilizing interactive virtual environments in which the properties of objects in the environment can be analyzed by virtual measurement instruments and displayed for the purpose of illustrating principals, exploring subjects and presenting information for a user, such as a student in a course of study. Learning is facilitated using a virtual environment such as those created in video games, presented using software on a computer or mobile device, where students can enter, as an avatar, any place at any time and at any size to pursue a number of activities. The virtual environment is observed by the student on the device display screen or using a virtual reality headset. The student can move the avatar about the environment and observe the objects in the surroundings. The student can select an object in the environment and determine its many properties by using the variety of virtual measurement instruments supported by the system.

The learning system of the present invention provides a virtual environment having objects and/or organisms whose properties are to be determined as a goal of a game or lesson. The virtual environment is a 3 dimensional representation of a scene, such as, for example, the earth during the cretaceous period, the interior of an object such as an automobile engine cylinder, the blood vessels in a human body, or a galaxy. The virtual environment can represent scenes at various scales, from atomic to cosmic. The game player or student can move about the virtual environment and examine various objects or organisms using various instruments.

There are many examples of possible computer games and lessons using virtual measurement instruments that can be created using the system of the present application. For example, a game or lesson can be configured to solve a crime by assembling available evidence. Virtual crime scenes can be provided and a player or student can select from a variety of virtual measurement instruments to examine evidence in the scene. For instance, the forensics game or lesson could employ instruments for finger prints, DNA analysis, blood analysis, hair analysis, bullet identification, firearms analysis, gun shot residue, drug screening, breath analysis, chemical composition, compound analysis, odor, size, age, molecular structure view, chemical activity view, DNA analysis, X-ray image, CAT scan, image analysis, microscopic view, gas chromatograph, mass spectrometer, infrared spectrometer, visible spectrometer, drug screen, blood pressure, pulse rate, and other physical and chemical properties, etc.

In another example, a game or lesson can be configured to explore a virtual scene for fossils. The virtual scene may include a fossil of a dinosaur that lived 65 million years ago embedded in a rock cliff in a virtual environment representing the ice age 50,000 years ago. For instance, the archaeological game or lesson could employ a rock dating probe to find the layer in the rock cliff corresponding to the age in which the dinosaur lived and then explore that layer to find the fossil. Further, the archaeological game or lesson could employ a virtual chemical compound analysis probe, thermal decomposition probe and other virtual measurement instruments to analyze the fossil's composition and structure.

Also, a game or lesson can be configured to diagnose the condition of a virtual patient. For instance, the health diagnostics game or lesson could employ virtual measurement instruments for temperature, odor, color, size, age, radioactivity, molecular structure view, chemical activity view, DNA analysis, X-ray image, CAT scan, image analysis, microscopic view, gas chromatograph, mass spectrometer, infrared spectrometer, visible spectrometer, breath analysis, blood analysis, drug screen, blood pressure, pulse rate, infrared camera, and other physical and chemical properties. Further, an art history game or lesson can be configured to diagnose art forgeries and identify other forgeries by the same culprit by employing virtual measurement instruments to determine the age of pigments, chemical composition of pigments and origin of pigments in a virtual art piece. Additionally, a cosmology game can be configured to identify the location of black holes by employing virtual measurement instruments to measure gravitational and magnetic fields and provide chemical and compound analysis to determine what elements are formed in star supernovae. The above examples show how virtual measurement instruments may be employed for a variety of games and lessons to teach various subject matters.

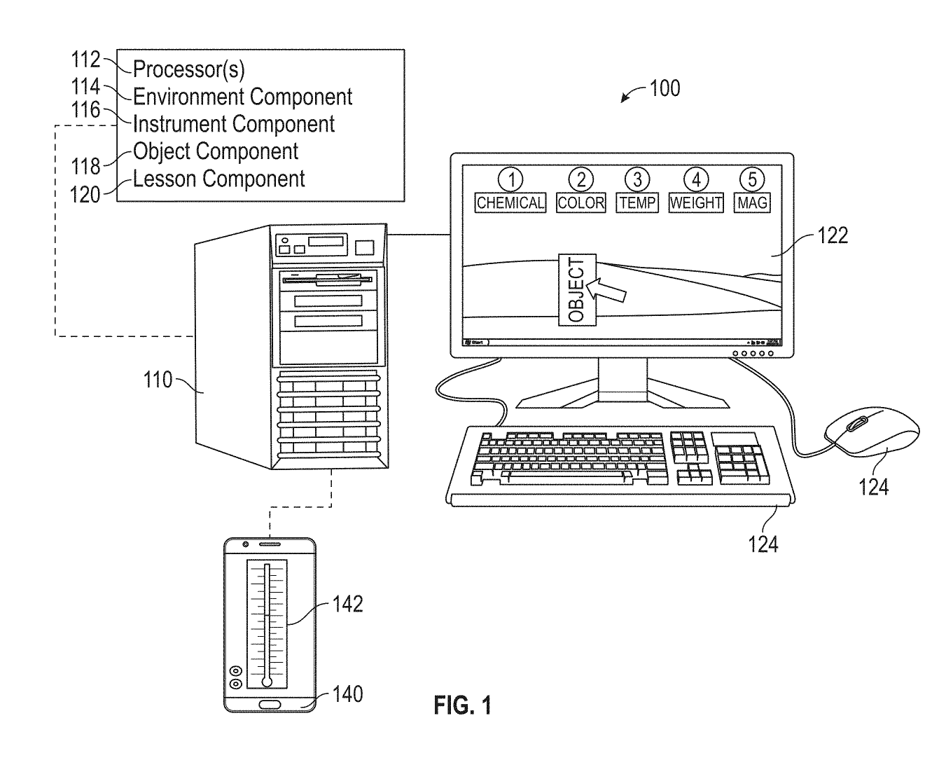

FIG. 1 illustrates a system 100 configured to provide a virtual environment to users for implementing a game or lesson. System 100 is only one example of a suitable computing environment and is not intended to suggest any limitation as to the scope of use or functionality of the features described herein. System 100 may include a computer device 110 comprising one or more processors 112 configured to execute one or more computer program components. The one or more computer program components may be implemented as one or more hardware components programmed with computer software. The one or more computer program components may also be implemented in programmable hardware devices such as field programmable gate arrays, programmable array logic, programmable logic devices or the like. The computer program components may include one or more of an environment component 114, an instrument component 116, an object/organism property component 118, a lesson component 120 and/or other components.

Environment component 114 may be configured to execute an instance of a game or lesson provided within a virtual environment. An instance of the virtual environment may be executed by computer components to determine views of the virtual space. The views may then be displayed to a user or multiple users via a display or multiple displays 122 associated with a computer device or multiple computer devices 110 connected digitally. Computer device 110 may be any suitable computer enabled device for displaying a virtual scene to a user, such as, for example, a computer, smartphone, tablet, robot, toy, VR headset, etc. Within the instance(s) of the virtual space, users may control characters, objects, and/or other elements within the virtual space to interact with the virtual space and/or each other. The virtual space may include an avatar representing a user in the virtual space. The avatar may be controlled by the user to move through the virtual space and interact with the virtual space (e.g., objects or organisms in the virtual space). The users may participate in the instance of the virtual space by controlling one or more of the available user-controlled elements in the virtual space. Control may be exercised through control inputs and/or commands input by the users through input component(s) 124 (e.g., keyboard, mouse, touchscreen, voice command, etc.) associated with computer device 110. Further, system 100 may also comprise an additional computer device 140 connected to computer device 110 via any suitable wired or wireless connection and configured to represent a virtual measurement instrument that can be used to examine objects/organisms in a virtual space. Computer device 140 may be any suitable computer enabled device that executes a software application to simulate and display the control features of a real measurement instrument. For example, computer device 140 may be, for example, a smartphone, tablet, etc.

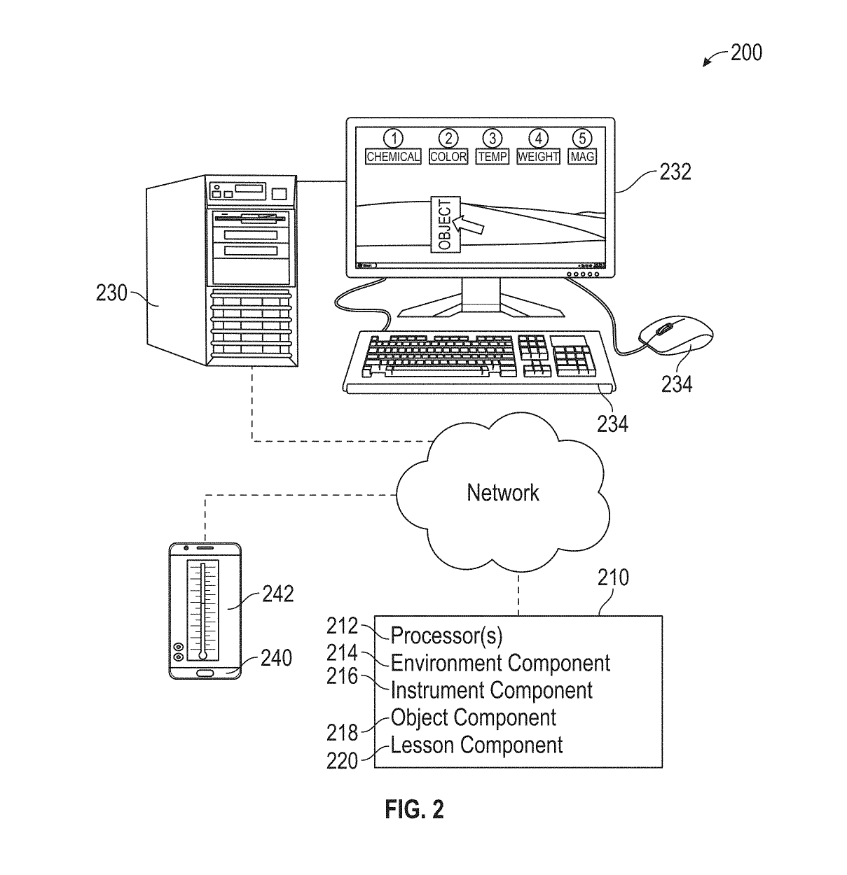

FIG. 2 illustrates a system 200 configured to provide a virtual environment to users for implementing an online game or lesson. System 200 is only one example of a suitable computing environment and is not intended to suggest any limitation as to the scope of use or functionality of the features described herein. In some implementations, system 200 may include a server or servers 210. Server 210 may be configured to communicate with one or more client computer devices 230 according to a client/server architecture including digital connections, such as for example, Wi-Fi, wire, cell phone connection, Bluetooth, the internet, an intranet, or other common connection means using communication standards such as TCP/IP. Users may access system 200 and/or the virtual space via client computer devices 230 to engage in an online game or lesson. Server 210 may be configured to execute one or more computer program components using one or more processors 212. The one or more computer program components can reside on a single server 210 or multiple servers 210 linked by digital connections, such as for example, Wi-Fi, wire, cell phone connection, Bluetooth, the internet, an intranet, or other common connection means using communication standards such as TCP/IP. The one or more computer program components may be implemented as one or more hardware components programmed with computer software. The one or more computer program components may also be implemented in programmable hardware devices such as field programmable gate arrays, programmable array logic, programmable logic devices or the like. The computer program components may include one or more of an environment component 214, an instrument component 216, an object/organism property component 218, a lesson component 220 and/or other components.

Environment component 214 may be configured to execute an instance of a game or lesson provided within a virtual environment. An instance of the virtual environment may be executed by computer components to determine views of the virtual space. The views may then be displayed to a user or multiple users via a display or multiple displays 232 associated with a computer device or multiple computer devices 230 connected digitally. Computer device 230 may be any suitable computer enabled device for displaying a virtual scene to a user, such as, for example, a computer, smartphone, tablet, robot, toy, VR headset, etc. Within the instance(s) of the virtual space, users may control characters, objects, and/or other elements within the virtual space to interact with the virtual space and/or each other. The virtual space may include an avatar representing a user in the virtual space. The avatar may be controlled by the user to move through the virtual space and interact with the virtual space (e.g., objects or organisms in the virtual space). The users may participate in the instance of the virtual space by controlling one or more of the available user-controlled elements in the virtual space. Control may be exercised through control inputs and/or commands input by the users through input component(s) 234 (e.g., keyboard, mouse, touchscreen, voice command, etc.) associated with computer device 230. Further, system 200 may also comprise an additional computer device 240 connected to server 210 via any suitable wired and/or wireless connection and configured to represent a virtual measurement instrument that can be used to examine objects/organisms in a virtual space displayed on display 232 associated with computer device 230. Computer device 240 may be any suitable computer enabled device that executes a software application to simulate and display the control features of a real measurement instrument on a display 242. For example, computer device 240 may be, for example, a smartphone, tablet, etc.

Environment component 114, 214 may be configured to create 3-dimensional environments using video game software engines such as Unity-3D, Amazon's Lumberyard or other such software. On example of a virtual environment for teaching is provided in a learning game called Mission KT, as described in U.S. application Ser. No. 14/756,737 filed on Oct. 7, 2015 and titled “EDUCATIONAL SYSTEM FOR TEACHING SCIENCE, HISTORY AND OTHER SUBJECTS,” which is hereby incorporated by reference in its entirety. The Mission KT game is designed for teaching the nature of atoms as the building blocks of all material objects. The science that is illustrated is the small size and enormous numbers of atoms, their stability over cosmic time scales, their recycling among plants, animals, the atmosphere and the oceans, and their formation in the Big Bang and Star Supernovae. The theme of the game, which is the first episode in a series of games called THE STARDUST MYSTERY, is “You are made of STARDUST that was once in the body of Albert Einstein and the Last T-Rex.” Players cooperate in teams as the crew of the Beamer time, space and dimensional travel machine to determine where their STARDUST (atoms) has previously been, where, when and how it was formed, and how it got from the T-Rex to them.

The view determined and transmitted to display 122, 232 may correspond to one or more selected view parameters, including a location in the virtual space, a zoom ratio, a point-of-view, and/or other view parameters. One or more of the view parameters may be selectable by the user. The instance of the virtual space may comprise a simulated space that is presented to a user via computer device 110, 230. The simulated space may have a topography, express ongoing real-time interaction by one or more users, and/or include one or more objects/organisms positioned within the topography that are capable of locomotion within the topography. In some instances, the topography may be a 2-dimensional topography. In other instances, the topography may be a 3-dimensional topography. The topography may include dimensions of the space and features of a surface or object in the space. The views may include additional content (e.g., text, audio, pre-stored video content, and/or other content) that describes particulars of the current state of the place beyond the graphics.

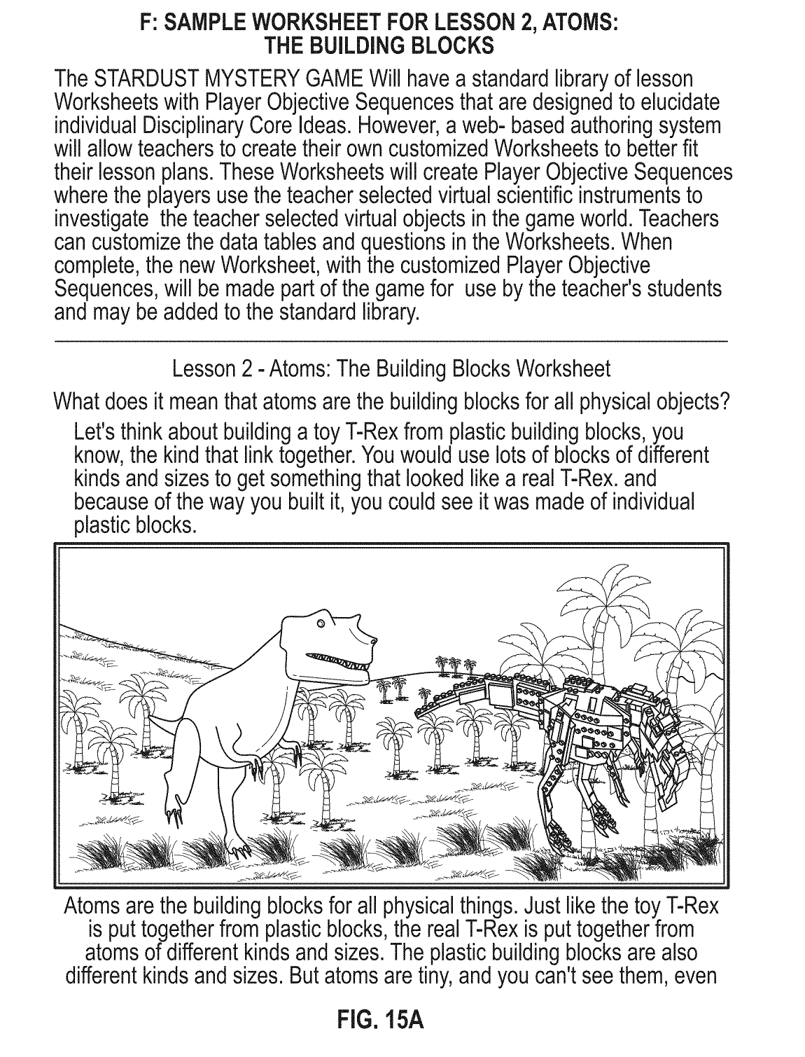

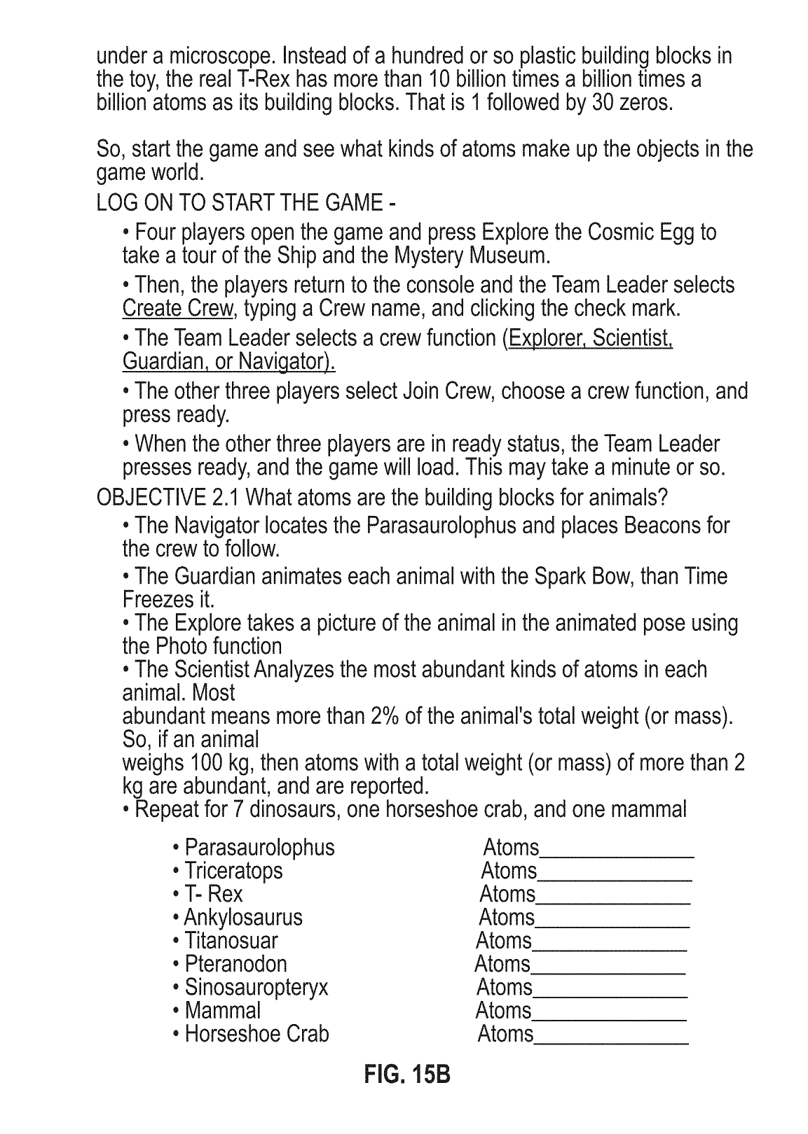

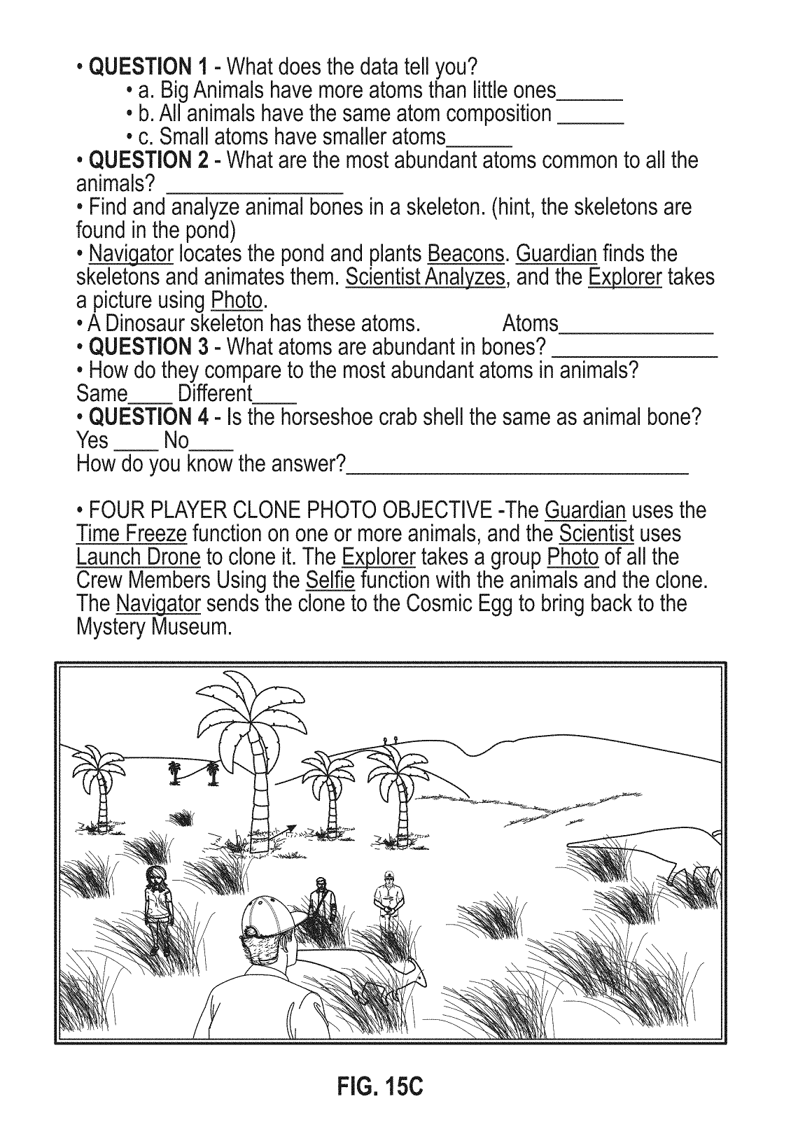

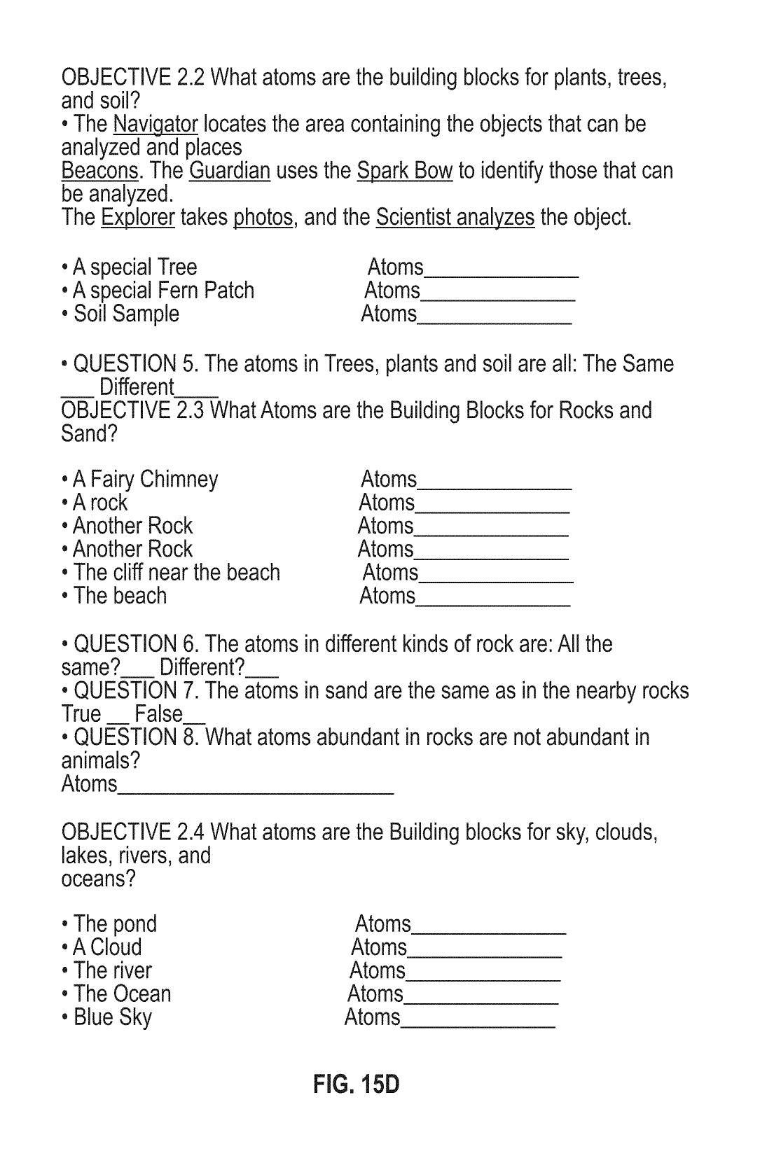

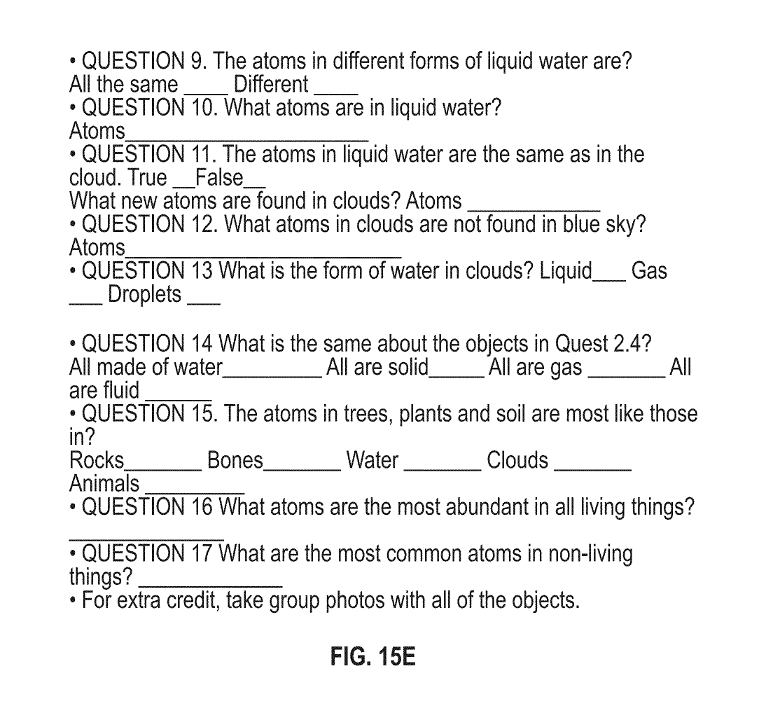

The systems of the present application may be used to present lesson plans to a user/student to illustrate scientific or other concepts. Lesson plans may be implemented by lesson component 120, 220 by presenting a player objective sequence to be completed by a user/student. The player objective sequence designates one or more virtual objects to be analyzed using one or more virtual measurement instruments. For example, a player objective sequence may require a user to select a series of objects to compare their properties and to find, for example, the oldest, the heaviest, the most iron rich, etc. Further, lesson component 120, 220 may present the user/student with worksheets for recording analysis and observations. For example, worksheets may include follow-up questions and tables for data entry. Lesson component 120, 220 may include a library of Player Objective Sequences with accompanying worksheets, which can be presented to a user/student via computer device 110, 230. Alternatively, a physical worksheet, rather than a digital worksheet, may be provided to guide the student in the investigation, to suggest measurements, to prompt the student to record data, and/or to prompt the student to answer questions that would assess the student's progress. The physical or digital worksheets would be available to the teacher as an assessment tool. FIGS. 15A-15E show a sample worksheet for use with the learning game called Mission KT.

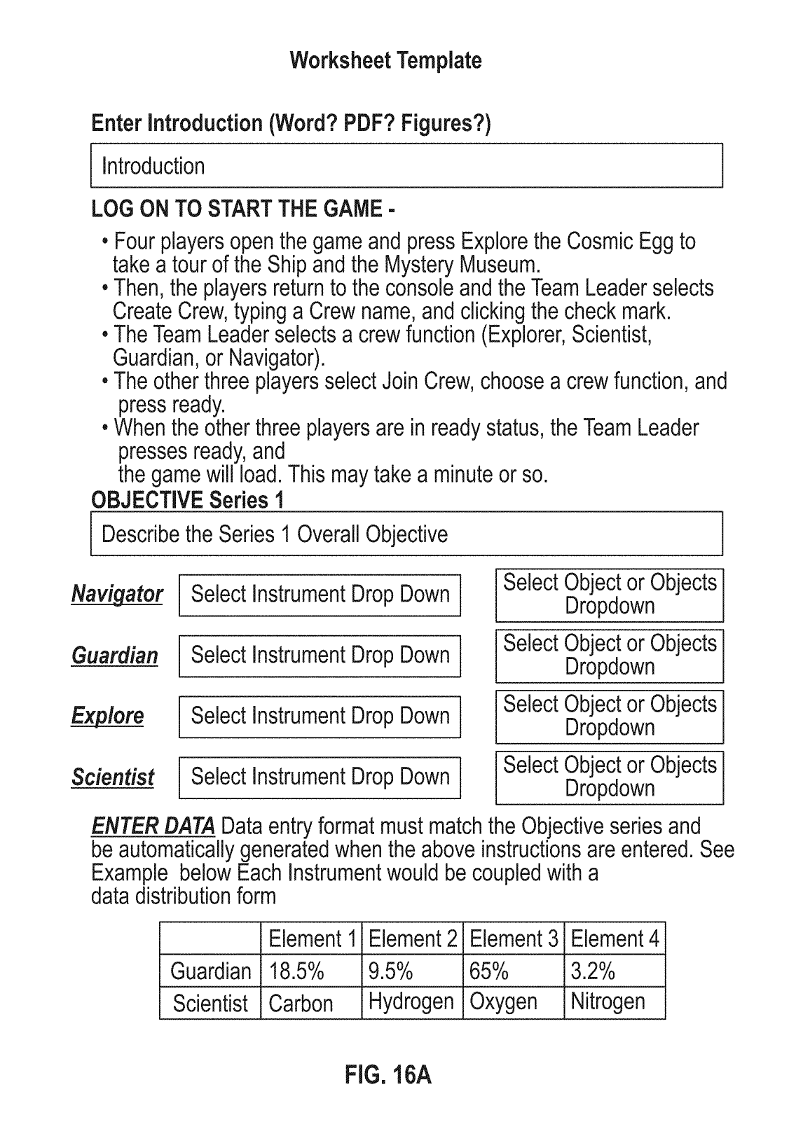

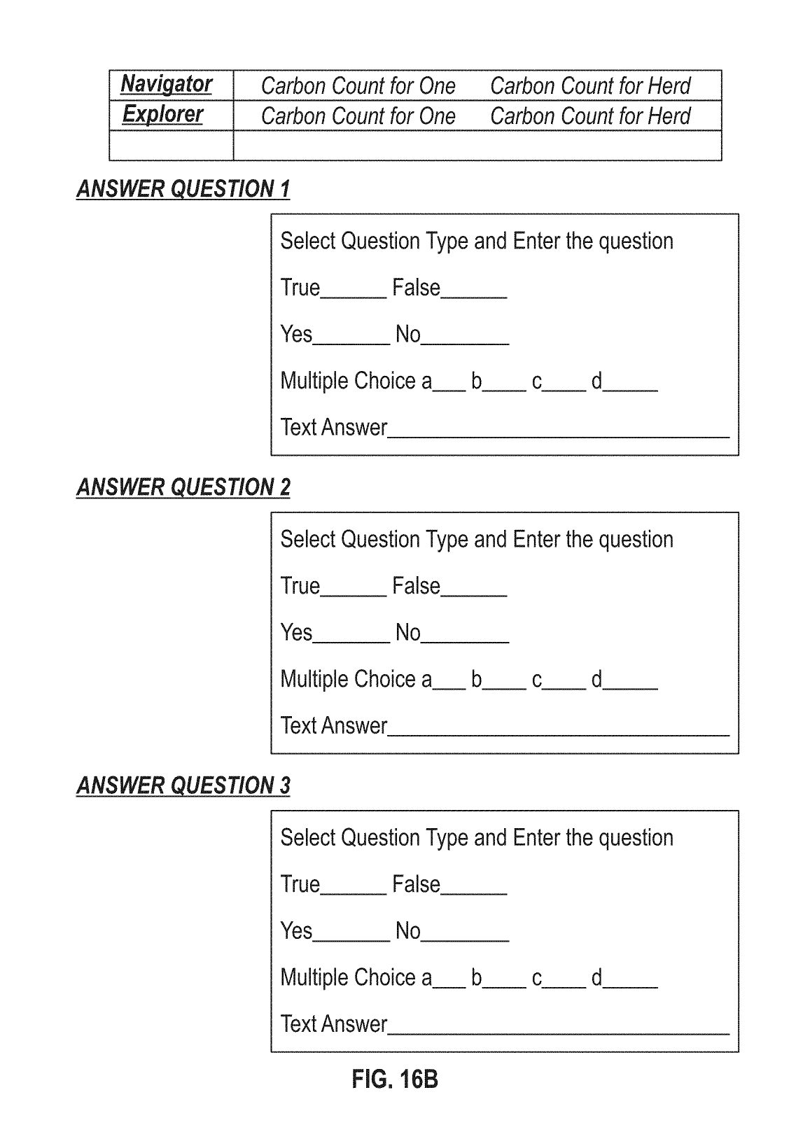

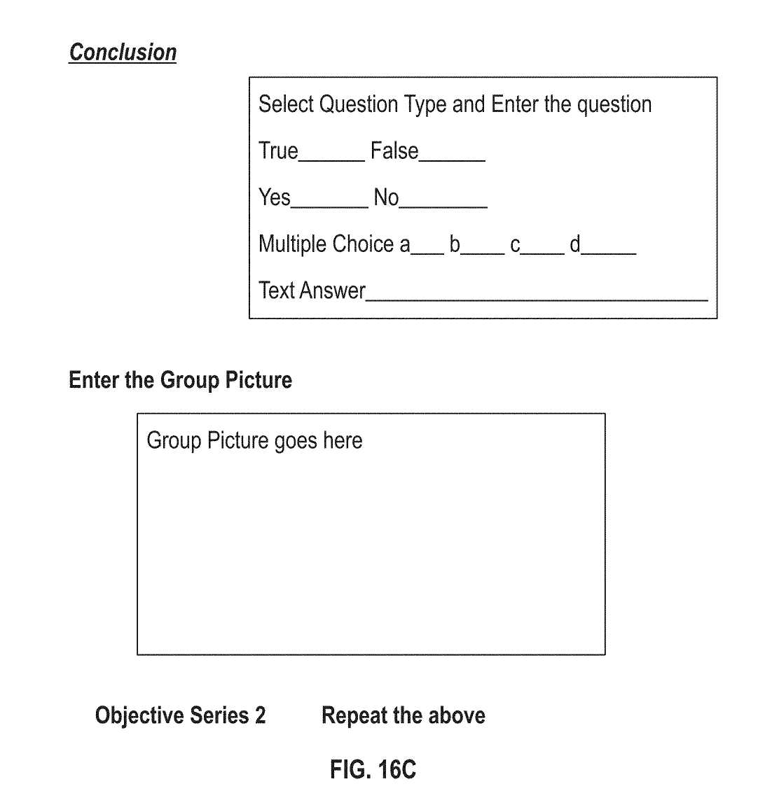

Further, lesson component 120, 220 may be configured to provide a user interface for creating custom Player Objective Sequences and worksheets that can be employed in the game and added to the library for sharing with other users if so desired. While standard worksheets may be created by a game developer, it is also possible for a teacher or instructor for a course or lesson to create customized worksheets. Such customized worksheets would contain the teacher designated player objective sequences combining various virtual instruments to be employed to analyze various virtual objects. The creation of such customized worksheets can be facilitated by the use of an authoring template available in digital form (or paper form for a non-digital implementation), which would allow selection of the sequence of objects and instruments, tables for data recording, questions to be posed with input space for answers and space for conclusions. An example of such a worksheet template is shown in FIGS. 16A-16C.

The player objective sequences and worksheets may be presented in text or multimedia formats in an interactive environment accessed by a user/student via computer device 110, 230, having a display screen 122, 232. A user/student is represented in the virtual environment by an avatar, which can be controlled by the user/student to move about the virtual environment and select various objects and examine the properties of the selected objects using virtual measurement instruments selected by the user/student. Control of the avatar and selection of virtual instruments and objects in the virtual environment may be exercised through control inputs and/or commands input by a user through input component(s) 124, 234 (e.g., keyboard, mouse, touchscreen, voice command, etc.) associated with computer device 110, 230. The player objective sequences define goals for the user/student to achieve in playing the game and lesson component 120, 220 logs the student's record of achieving those goals. For example, the player objective sequences may define a series of objects to be analyzed and the properties of the objects to be examined. Further, lesson component 120, 220 may store the records of the student's achievement of goals so that the student's progress is retained from session to session for the benefit of the student and/or the teacher of the subject or course. The player objective sequences and achievement of goals may be defined and evaluated based on player collaboration or competition among different players.

Table 1 below lists exemplary instruments and objects that can be provide in a game, such as, for example, Mission KT. For example, in the Mission KT, a user may create a lesson for Next Generation Science Standard (NGSS) Disciplinary Core Idea 134-A Evidence of common ancestry and diversity (topic in LS4: Biological evolution: Unity and diversity) by performing DNA Analysis on the animals in Mission KT and comparing the DNA to modern species to determine ancestry.

TABLE 1

| | Mission KT Virtual Game |
|---|---|
| Virtual Scientific Instruments | Objects |
| camera | Land Dinosaurs |
| microscope | Flying Dinosaurs |
| telescope | Fish |
| chemical composition, | Horseshoe Crabs |
| weight, | Sharks |
| temperature, | Turtles |
| chemical compound makeup | Mammals |
| cloning device | Reptiles |
| animation | Butterflies |
| hardness | Trees |
| thermal decomposition temperature | Plants |
| radiation emissions | Flowers |
| Radiation reflections, | Fossils |
| color | Rocks |
| odor | Sand |
| size | River |
| age | Ocean |
| DNA analysis | Pond |
| atomic inheritance probability counter | Clouds |
| X-ray image | Blue Sky |
| gas chromatograph, | Fairy Chimneys |
| mass spectrometer | Obsidian |
| infrared spectrometer, | Lava |
| visible spectrometer | Soil |
| electric field | Dust Layer from Impact |
| magnetic field | Molten Dust Particles |
| gravitational field | Exhaled Air from Dinosaurs |
| nuclear force | Respiration from Plants |
| molecular structure | Bones |

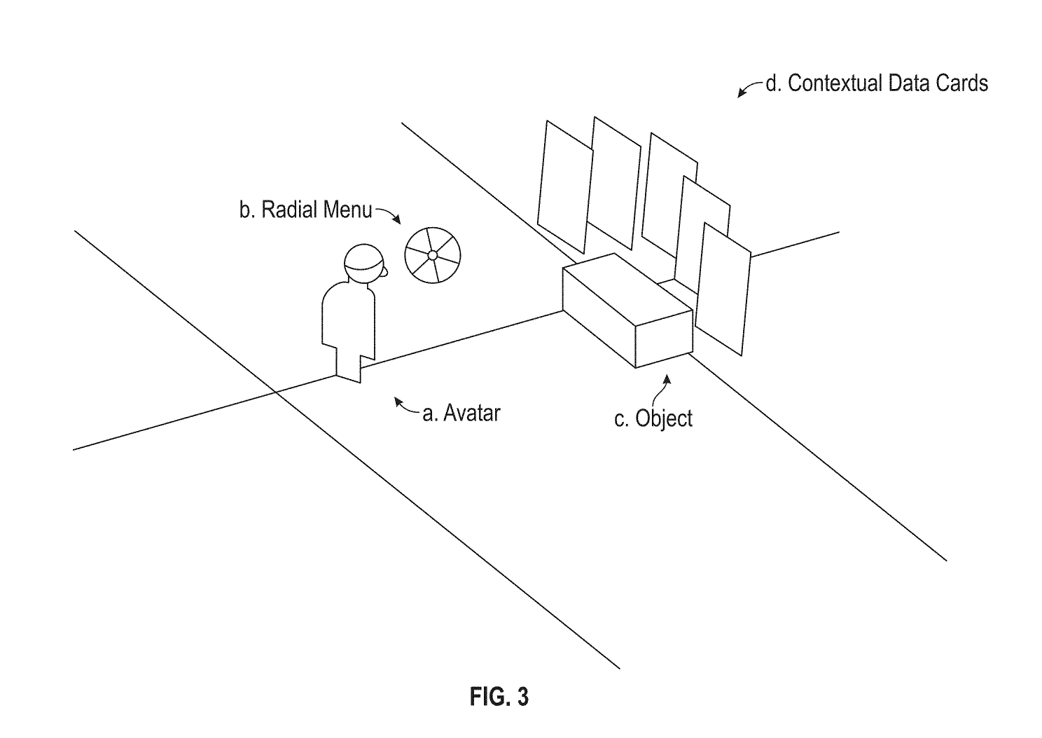

FIG. 3 provides a generic illustration of an avatar examining an object in a virtual environment by selecting one or more virtual measurement instruments from a menu to determine one or more properties of the object. The system of the present application provides standard file formats and templates by which the virtual measurement instruments and objects can be integrated in a virtual game environment with common game engine software such as Unity 3D, Amazon's Lumberyard, or the like. By creating a library of virtual measurements instruments, object file formats, and presentation instructions, with standards and utilities for integration with common game engine software such as Unity 3D, Amazon's Lumberyard, or the like, computer-based lessons and games which employ the virtual scenes and virtual instruments can be facilitated to illustrate principals, explore subjects and present information. The method and system of the present invention provide a rich set of tools for the creation of learning games or lessons on a variety of subjects. Also, creation of a library of virtual instruments with the standards and software for integration into standard game software programs and the corresponding template for the object properties file can greatly facilitate the implementation of such virtual measurement instruments in games and lessons.

A library of virtual measurement instruments is available to a user via a menu. As shown in FIG. 3, for example, a radial menu may be used to display the plurality of virtual measurement instruments available and select one or more of the instruments. Selection of one or more virtual instruments may be accomplished through control inputs and/or commands input by a user through input component(s) 124, 234 (e.g., keyboard, mouse, touchscreen, voice command, etc.) associated with computer device 110, 230. A combination of measurements for a common object may be made by selecting several virtual measurement instruments for simultaneous application. Instrument component 116, 216 stores the library of virtual measurement instruments and corresponding instruction files with standards and utilities for integration of the virtual measurement instruments in a virtual game environment with common game engine software such as Unity 3D, Amazon's Lumberyard, or the like. Each virtual measurement instrument has an associated instruction file that defines certain aspects of the virtual measurement instrument, including the availability of the virtual measurement instrument in a given virtual scene, the interaction of the virtual measurement instrument with one or more objects in a given virtual scene and/or the graphical presentation of the virtual measurement instrument.

The library of instruments includes a plurality of instruments for determining various properties. The library of instruments may include at least the following: chemical composition analyzer, atom inheritance probability probe, dynamic periodic table, thermal decomposition analyzer, radiation detector, odor sensor, electric field sensor, magnetic field sensor, gravitational field sensor, nuclear force detector, radioactive rock dating probe, carbon dating instrument, chemical compound analyzer, scale (object weight), object temperature sensor, molecular structure analyzer, gas chromatograph, mass spectrometer, infrared spectrometer, visible spectrometer, x-ray machine, CAT scan machine, MRI machine, finger print analyzer, DNA analyzer, blood analyzer, hair analyzer, bullet identification machine, firearms analysis machine, gun shot residue analyzer, drug screening machine, breath analyzer, blood pressure monitor, and pulse monitor. Selected virtual measurement instruments are graphically represented as a 3-D or 2-D replica of the instrument, including the features of the instruments, such as, for example, meters, dials, number displays, etc. For example, a virtual measurement instrument may be graphically represented on a display 122, 232 associated with a primary computer device 110, 230. Computer device 110, 230 may be any suitable computer enabled device that executes instrument component 116 for simulating and displaying the control features of a measurement instrument on display 122, 232. Control of the virtual measurement instrument represented on display 122, 232 associated with primary computer device 110, 230 may be exercised through input component(s) (e.g., keyboard, mouse, touchscreen, voice command, etc.) associated with primary computer device 110, 230.

Alternatively, for example, a virtual measurement instrument may be graphically represented on a display 142, 242 associated with a secondary computer device 140, 240. Computer device 140, 240 may be any suitable computer enabled device that executes a software application to simulate and display the control features of a measurement instrument on display 142, 242. Further, secondary computer device 140, 240 executes the software application and communicates with instrument component 116 of computer device 110 or instrument component 216 of server(s) 210 so that use of the measurement instrument represented on the secondary computer device 140, 240 is coordinated with the play of the game or lesson depicted in the virtual environment presented on the display 122, 232 associated with the primary computer device 110, 230. Computer device 140, 240 may be, for example, a smartphone, tablet, etc. Control of the virtual measurement instrument represented on display 142, 242 associated with secondary computer device 140, 240 may be exercised through input component(s) (e.g., keyboard, mouse, touchscreen, voice command, etc.) associated with secondary computer device 140, 240.

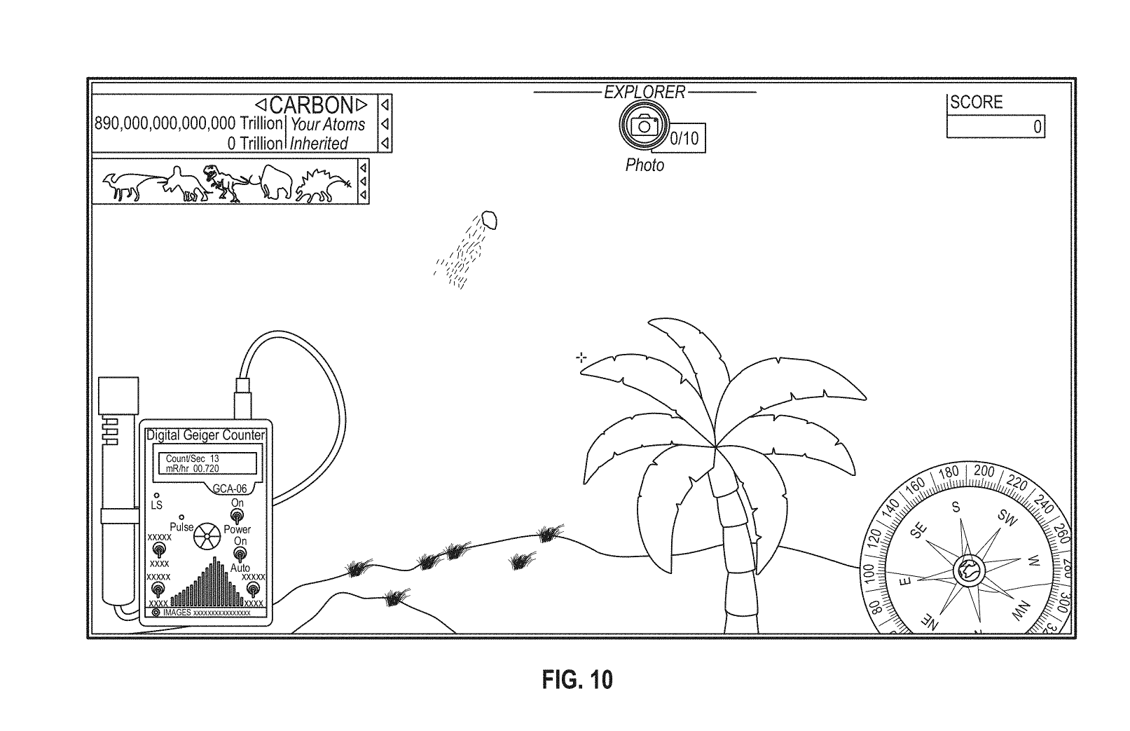

FIGS. 1 and 2 show an exemplary virtual thermometer represented on the display screen 142, 242 of a smartphone 140, 240 showing a thermometer image with the temperature indicated by the level of the thermometer's fluid. Further or alternatively, the secondary computer device's 140, 240 speakers could be used for results presented as sound. For example, the secondary computer device 140, 240 may represent a Geiger counter, with the display screen 142, 242 showing a meter with the radioactivity indicated by a needle on the meter, while the device speakers represent the clicking sound of a Geiger counter. As shown in FIG. 10, the same result could of course be obtained using part of the display screen 122, 232 and device speakers or headphones of computer device 110, 230.

As shown in FIG. 3, one or more objects may be presented in the virtual environment for an avatar to interact with using a selected virtual instrument. An object in the virtual environment may be selected for examination through control inputs and/or commands input by a user through input component(s) 124, 234 (e.g., keyboard, mouse, touchscreen, voice command, etc.) associated with computer device 110, 230. When the object is selected, the object is examined using the selected virtual measurement instruments to determine the selected object's properties. A combination of measurements for a selected object may be made by selecting several virtual measurement instruments for simultaneous application. Object component 118, 218 stores a plurality of objects and corresponding data structures with standards and utilities for integration of the objects in a virtual game environment with common game engine software such as Unity 3D, Amazon's Lumberyard, or the like. Each object has an associated data structure that contains data regarding various properties of the virtual object.

The data structure may implement a standard template for storing the object properties and may comprise various categories of data that can be implemented by a developer and be made available for use by other game developers. Data fields in the data structure may include various data formats, including a numerical value, Boolean data type, name, date, series of files, 3D model, 2D image, list, sound, video, vector field, etc. Each data structure for an object contains some or all of these fields as required by the simulation and digital instructions for how the property is to be presented in game or lesson. For example, the data structure for an object may include instructions regarding the conditions under which a property is to be displayed, the conditions under which a value/condition of the property is to be displayed, etc. Some properties may depend on the conditions in the environment or properties of other objects in the environment. For example, weight of an object measured on earth would be different from that measured on the moon, or the color of an object could change depending on the local temperature. The properties may include at least the following: weight, temperature, chemical compound makeup, hardness, thermal decomposition temperature, radiation emissions or reflections, radioactivity, odor, electric field, magnetic field, gravitational field, nuclear force, color, size, age, molecular structure view, chemical activity view, DNA analysis, atomic inheritance probability counter, X-ray image, CAT scan, image analysis, microscopic view, gas chromatograph, mass spectrometer, infrared spectrometer, visible spectrometer, breath analysis, blood analysis, drug screen, blood pressure, pulse rate, fingerprints on the surface, surface image for hair matching or firearm identification, and other physical, chemical and image related properties.

FIG. 1 illustrates a generic object in a generic virtual environment, which can be selected to examine various properties of the object. For example, as shown in FIG. 1, the display screen 122, 232 of the primary computer device 110, 230 may present various properties associated with an object in the form of contextual data cards that are displayed upon selection of the object. In the example of FIG. 1, there are 5 possible properties that can be measured, each with an identification (ID) number. A property to be measured may be selected through control inputs and/or commands input by a user through input component(s) 124, 234 (e.g., keyboard, mouse, touchscreen, voice command, etc.) associated with computer device 110, 230. The measure property is displayed on the screen. The property can be a single value (e.g., temperature), a multiple value property (e.g., chemical composition), a field (e.g., a magnetic or electric field), a diagram (e.g., chemical structure), a graph, a video, or other appropriate presentation of a property of an object. Multiple properties of a given object can be examined by selecting different properties of the object as many times as desired.

In one embodiment, a property may be selected by using the keyboard to designate the appropriate property ID number, and a measurement is made by placing a cursor on the object using a mouse or touchpad and clicking to clicking on the object. It should be understood, however, that there are various other ways of selecting a property and initiating measurement of the selected property. For example, a property may be selected by clicking a cursor on the desired property using a mouse, touchpad, touchscreen, voice command, etc., and measurement of the selected property may be initiated by actuating control features of a virtual measurement instrument presented on the display 142, 242 of a secondary computer device 140, 240 using input component(s) (e.g., keyboard, mouse, touchscreen, voice command, etc.) associated with the secondary computer device 140, 240.

Table 2 below is a summary of the standards for the kinds of measurements that can be made, the data resulting from the measurement and the method of presentation. The creation of standards will allow for easy application of standard virtual instruments in different games facilitating learning through familiarity with the measurements.

TABLE 2

| Object | Category | Data within category | Display |
|---|---|---|---|
| Object | Scientific Instrument | Corresponding Object Properties | Display Type & |
| Name/Type | or Measurement | | Location |
| Human Patient | Vital Signs | Heart Rate, Blood Pressure, Blood Type, | Pop-up card at cursor |
| | | | location, graph, sound |
| Human | Finger Print | Finger Print Library | Data Card with subject |
| | | | match, picture of |
| | | | match, video |
| Human | Facial Recognition | Photo Library | Data Card with subject |
| | | | match, picture of |
| | | | match, or video |
| Human/Animal | Shared Atoms from | lifespan of animal/human from which | Pop up card or |
| | animal/human | atoms were inherited, Size of | Counter, pictures or |
| | | animal/human. Time between atoms | videos |
| | | released and atoms absorbed, | |
| | | Equilibration with Deep Ocean. | |
| Human/Animal | MRI | MRI file set rendered into 3D Model | Superimposed Image |
| Gun or Bullet | Fire Arms | 2D image of Striations on Bullet, | Pop up analysis report |
| | Identification | Gunpowder pattern, Firing Pin | |
| | | impression, Caliber, | |
| Human/Animal | DNA Analysis | DNA Dataset | Pop up card with |
| | | | subject match |
| Object | X-Ray Mode | Model & texture for model swap | Superimposed image |
| Object | Heat Distribution | For Infrared Spectrometer, a specialized | Superimposed |
| | | texture for this view mode | temperature map. |
| | | | graph, video |
| Object | Transform Size | In-game data for position and scale of an | Object transformation, |
| | | object in game | video, 3-D image |
| Object | Atom Inheritance | Type of object, age of object, Atom Type | Pop up card of counter, |
| | Probability | | image or video |
| Object | Temperature or | Temperature reading or Temperature | Pop up card or |
| | Temperature | Map | superimposed image, |
| | Distribution | | Image of instrument |
| | | | showing value, graph, |
| | | | video |
| Object | Physical State with | Solid, liquid, gas, plasma, Temperature | Pop up card at location |
| | corresponding | | of the cursor. Meter |
| | temperature/ | | showing value, Image |
| | pressure data/ | | of instrument showing |
| | Solubility per state | | value, graphs or videos |
| | | | or sounds |
| Object | Physical Properties | Color, Density, Volume, Mass, | Pop up card at location |
| | | Boiling Point, Melting Point, | of the cursor. Meter |
| | | Absorption, Albedo, Area, Brittleness, | showing value, Image |
| | | Capacitance, Concentration, Dielectric | of instrument showing |
| | | Constant, Ductility, Distribution, | value, graphs, images, |
| | | Efficacy, Flexibility, Flow rate, Fluidity, | videos, sounds |
| | | Length, Height, Depth, Luster, | |
| | | Malleability, Pressure, Reflectivity, | |
| | | Strength, Tension, Thermal Conductivity, | |
| | | Viscosity, volume, wave impedance | |
| Object | Electrical Properties | Electric Charge, Electrical Conductivity, | Pop up card at location |
| | | Electrical Impedance, Electrical | of the cursor. Meter |
| | | Resistivity, Frequency, Inductance, | showing value, Image |
| | | Intrinsic Impedance, Irradiance, | of instrument showing |
| | | Luminance, Magnetic Field, Magnetic | value, graphs, videos |
| | | Flux, Radiance | or sounds |
| Object | Dynamic Properties | Velocity, Acceleration, Location | Pop up card, Meter |
| | | | showing value, Image |
| | | | of instrument showing |
| | | | value, graphs, videos |
| | | | or sounds |
| Object | Chemical Properties | Reactivity with other chemicals, toxicity, | Pop up card, Meter |
| | | coordination number, flammability, | showing value, Image |
| | | enthalpy of formation, the heat of | of instrument showing |
| | | combustion, oxidation states, chemical | value, graphs, images |
| | | stability, types of chemical bonds that | or videos |
| | | will form | |
| Object | Elemental | Periodic Table with percent of elements | Periodic Table, Pop up |
| | Composition | present and the ratios contained within | card, Meter showing |
| | | the object | value, Image of |
| | | | instrument showing |
| | | | value |
| Object | Thermodynamic | Enthalpy, Entropy, State Functions, | Pop up card, Meter |
| | | Chemical Potential, Combustibility, | showing value, Image |
| | | Compressibility, Cryoscopic Constant, | of instrument showing |
| | | Curie Constant, Heat Capacity, Heat | value, graphs, images, |
| | | Flux, Heat Rate, Internal Energy, Internal | videos, sounds |
| | | pressure, Rate of Heat Flow, Thermal | |
| | | Conductivity, Thermal Efficiency, | |
| | | effusivity, Thermal Energy, | |
| | | Thermal Entrance Length, Thermal | |
| | | Velocity, Trouton's Ratio, Vapor | |
| | | Pressure, Volatility | |

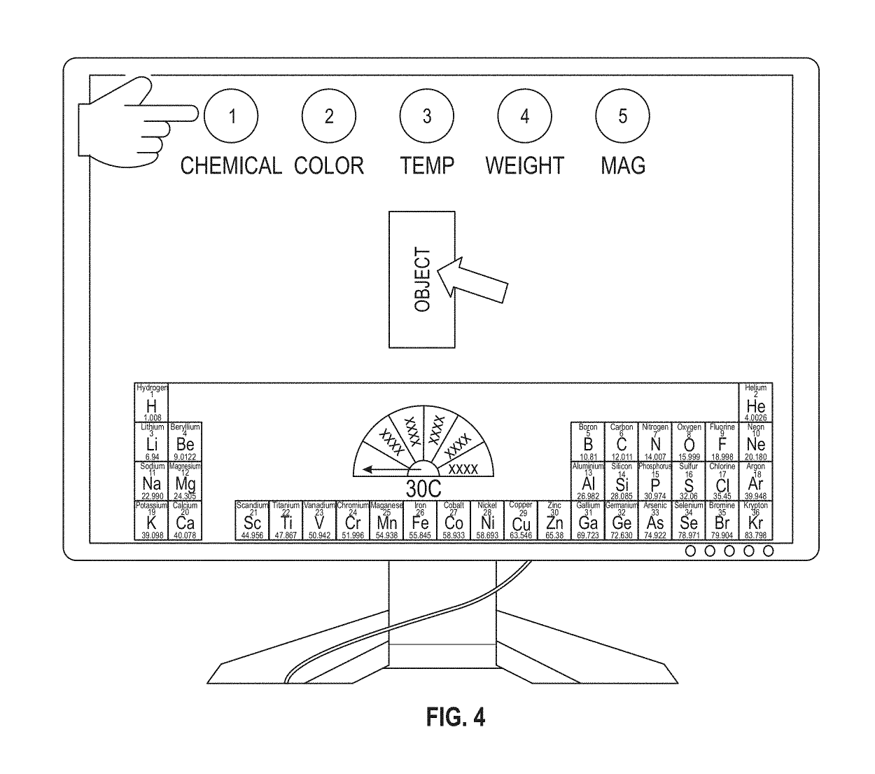

FIG. 4 presents an example of how the chemical composition and temperature of an object might be presented. In the example, the combination of properties can be selected by pressing both the 1 and 3 keys. Pressing the key a second time deselects the measurement. Having selected the properties, pointing and clicking on the object results in the properties being displayed. Both a temperature meter and periodic table pop up on the screen. The meter shows the temperature and the table shows the composition. The highest percentage element is shown in yellow and lower percentages in green. Trace elements are shown in purple. Passing the mouse cursor over the element box can reveal the actual percentage compositions. Alternatively, the compositions may be displayed in the appropriate box in the table.

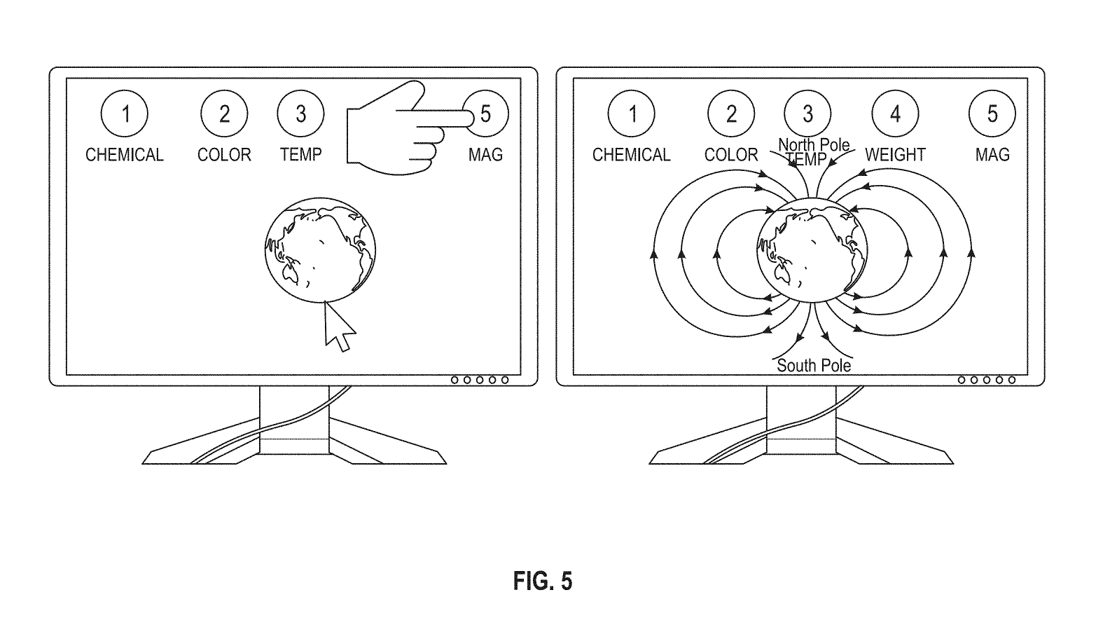

FIG. 5 illustrates the display of the magnetic field for the earth. For example, a user can select the Magnetic Field property of the earth by entering ID number 5 corresponding, and then the user can point and click on the object (i.e., the Earth) to show the magnetic field overlaid on the virtual environment.

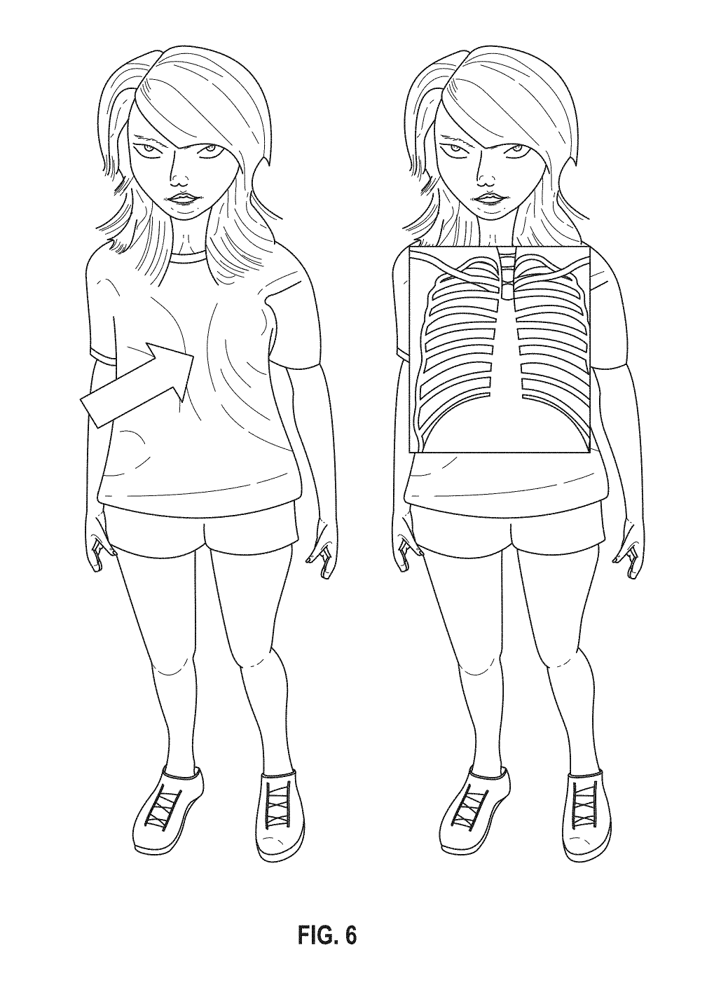

FIG. 6 illustrates the display of an X-Ray superimposed on a virtual human figure. A user can select X-Rays from the library of virtual measurement instruments, and then the user can point and click on the portion of the human figure to be x-rayed (shown as the chest area in this example). The system then superimposes the X-Ray image in the proper location on the human figure.

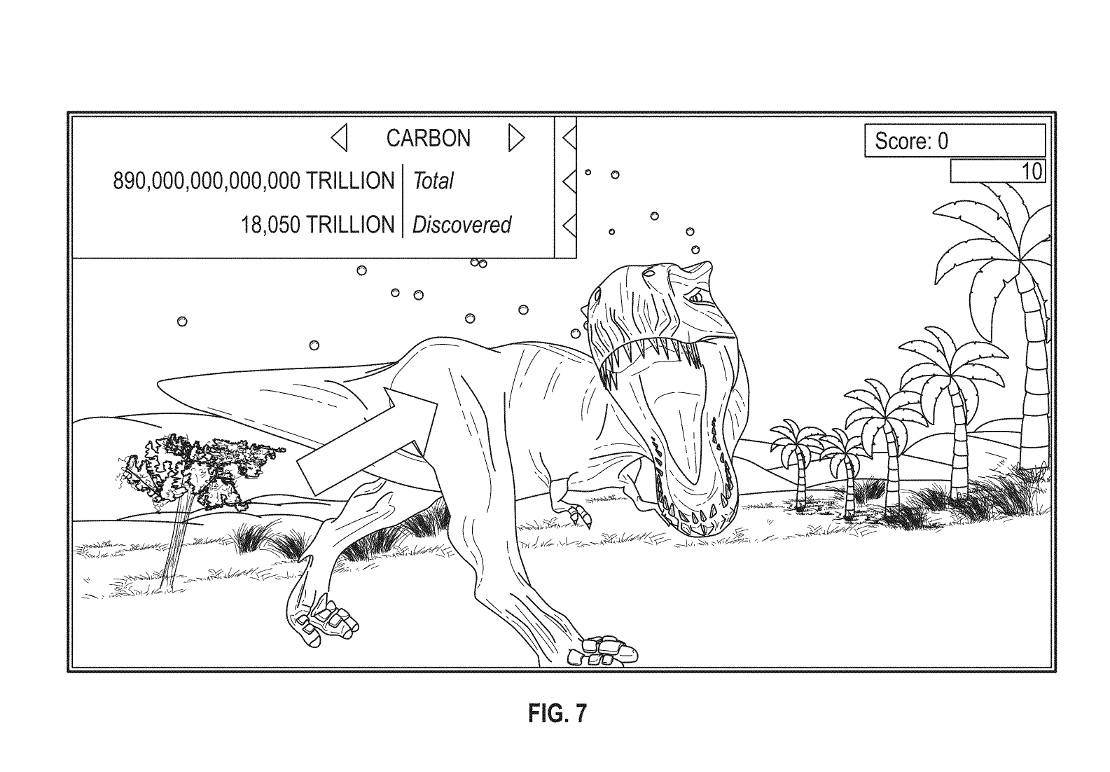

FIGS. 7-14 show various examples implemented in the Mission KT game. In the Mission KT game, the players have traveled back in time to the era of dinosaurs to determine where their carbon atoms have previously been. Objects in the scene, like the T-Rex and the plants have a property data structure that includes the calculated probable number of carbon atoms in that object that were inherited by the player. The carbon atoms exhaled by the T-Rex have now been uniformly distributed throughout the Earth's atmosphere, plants, animals and oceans, so the fraction of carbon atoms once exhaled by a particular T-Rex is roughly 5 out of every trillion. Since a body has roughly 900 trillion carbon atoms, each person will have roughly 4,500 carbon atoms inherited from a particular T-Rex.

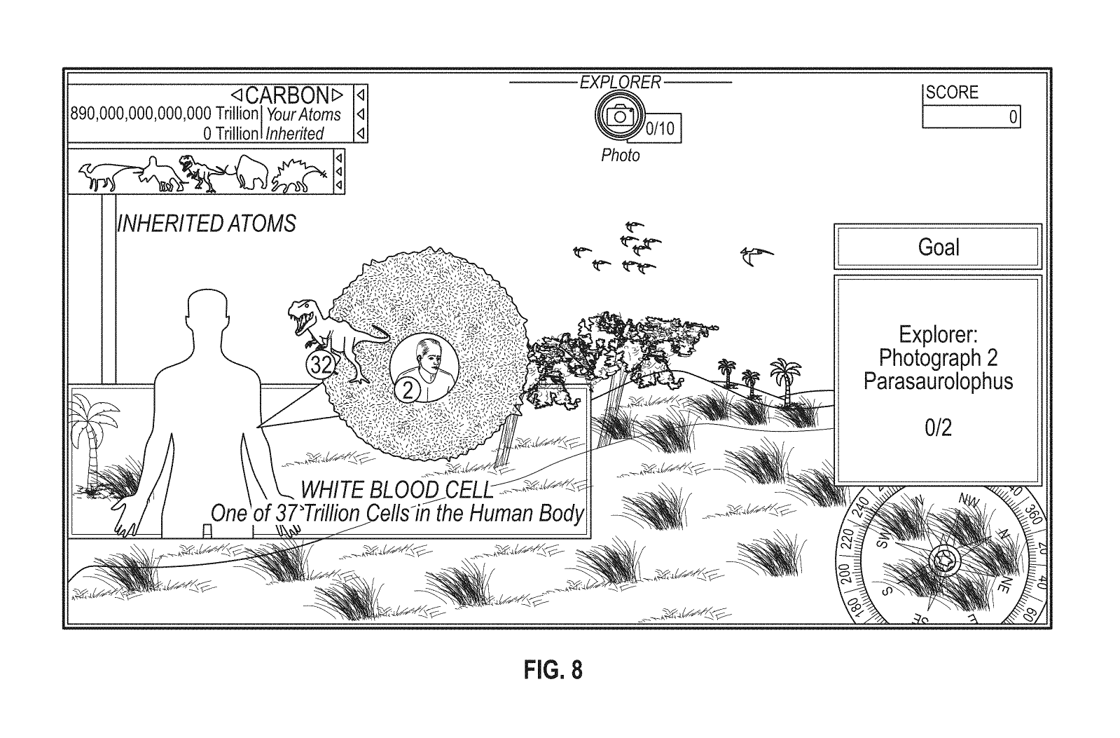

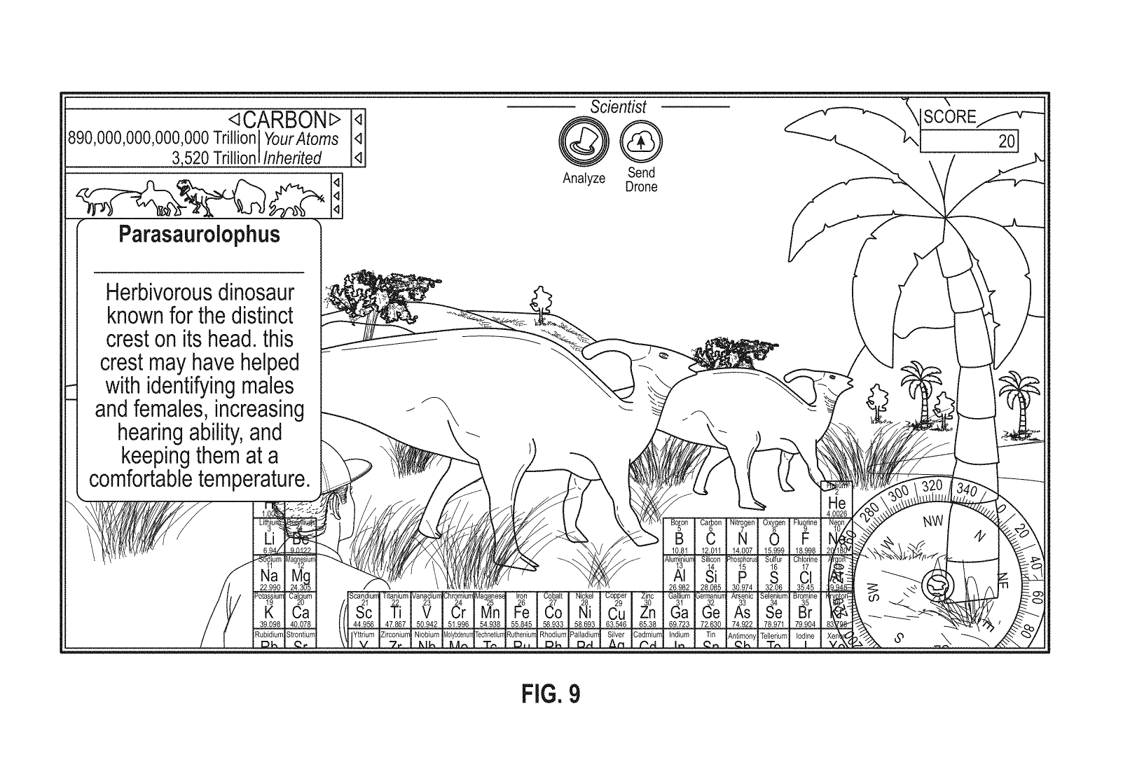

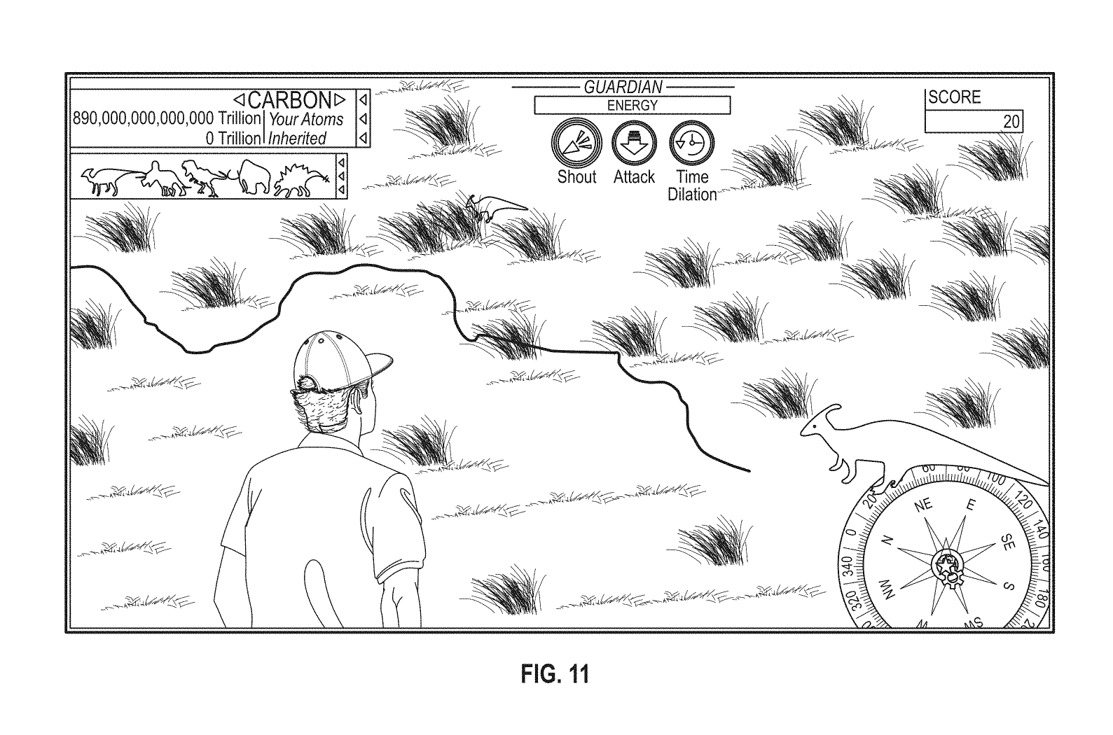

FIG. 7 illustrates a probe that reports the probable number of carbons in the selected object that have been inherited and are presently in the player or student. The lower green number is the total for all the objects so far identified including the T-Rex 4500 trillion. The upper red number is the total number of carbon atoms in the player's body. Alternatively, as shown in FIG. 8, the number of inherited T-Rex carbons in a student's white blood cells can be determined. The calculation indicates that every white blood cell has 32 carbons inherited from a particular T-Rex. FIG. 9 shows a chemical analysis probe implemented in the Mission KT game. As shown, a periodic table may be displayed showing the major elements in a selected object located in the center cross hairs of the image (a dinosaur in this example). Additional information on percent concentration can also be made available by passing the cursor over each element. FIG. 10 is an illustration of a compass in the Mission KT game (lower right hand corner) that allows players to find locations and one another in game play. FIG. 10 also shows a virtual digital Geiger counter (lower left corner) that shows local radioactivity. FIG. 11 is an example of an odor detector in the Mission KT game showing a scent trail as a green line superimposed on the environment and a Parasaurolophus clone that can follow the scent like a bloodhound would follow an odor trail.

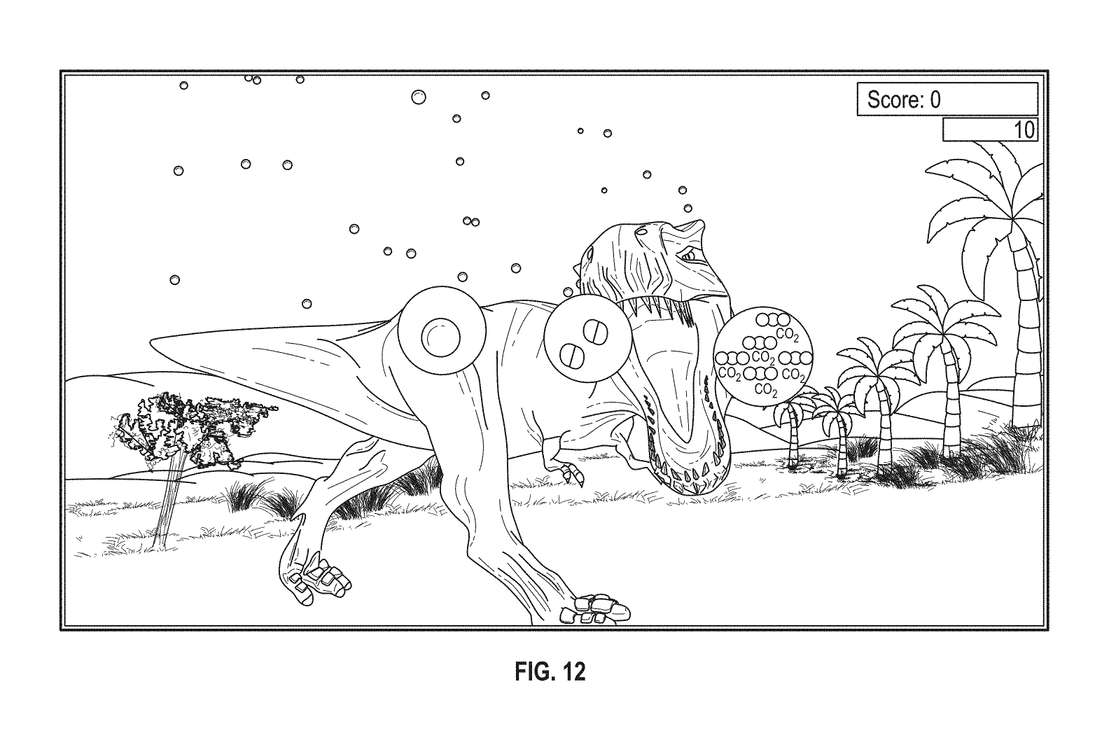

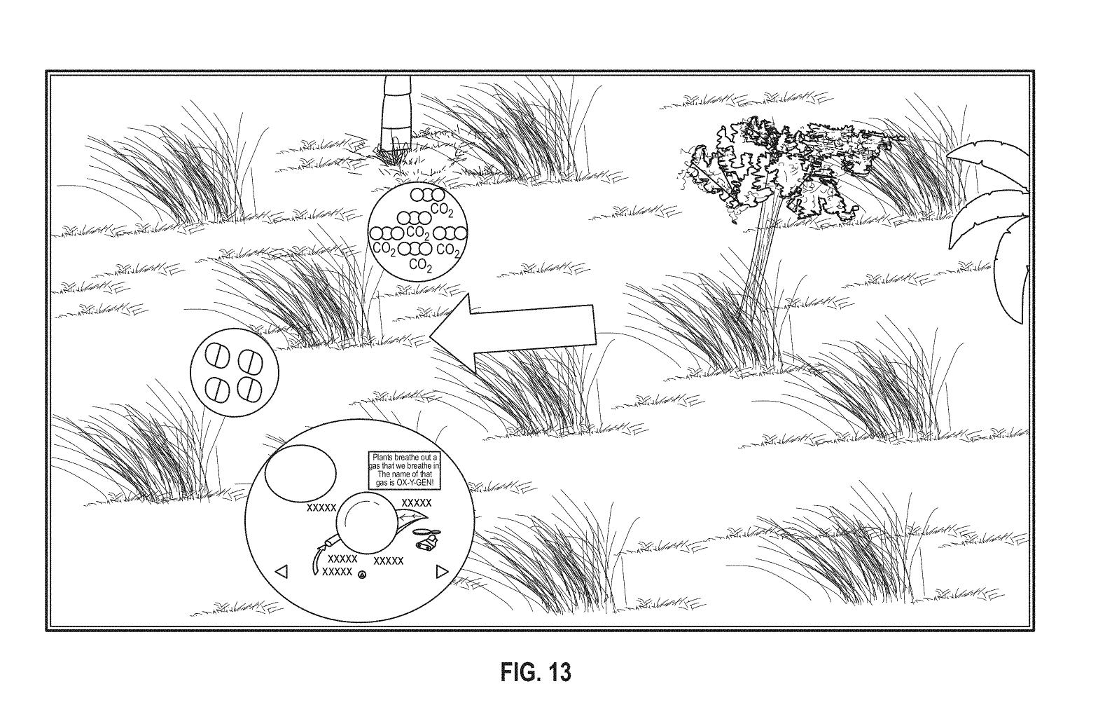

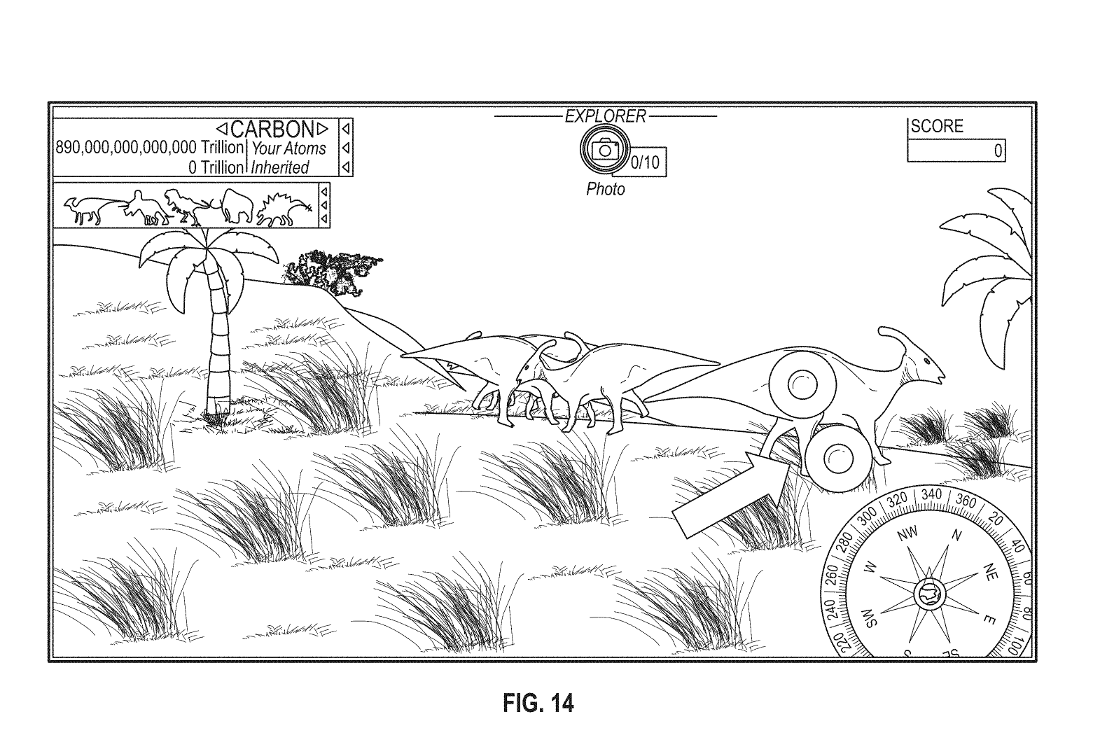

To illustrate the recycling of carbon, the Mission KT game may support the application of a microscopic chemical analysis probe that shows chemical analysis on a molecular level. Examples are shown in FIGS. 12 to 14. FIG. 13 is an illustration of a virtual measurement instrument that presents the compound analysis of a selected location as an image, enlarged to molecular scale, of the molecules present in that location. The results of a measurement are shown in a white circle in the area selected. Oxygen is measured during an inhale, CO2 during an exhale and the carbon in the body at any time. Other molecules are ignored for illustrative purposes. Important to the carbon cycle, the measurement indicates the inhaling of oxygen and exhaling of carbon dioxide as the oxygen is combined with carbon contained in sugars in the body. A chemical analysis virtual instrument may be used to show the chemical reaction. FIG. 13 shows the path of the carbon as it is taken in by plants and converted to sugars by photosynthesis with oxygen as a byproduct. The photosynthesis reaction may be illustrated by a video played in the circle. FIG. 14 shows how the carbon is now cycled to the new dinosaur as it eats the plant. The carbon probability probe discussed for FIG. 7 may be modified to show the number of carbon atoms that the parasaurolophus has inherited from each T-Rex.

A primary objective of the present invention is to provide a system to create a configurable game or lesson in which a Game Author such as a teacher, student or subject matter expert may create a customized game to meet the objectives of a lesson. Within the system, the Game Author can select from a number of stored libraries, the world or environment in which the game or lesson is to be conducted by the players, which may be represented as avatars, the objects in the world or environment which are to be investigated, and the instruments or capabilities used by the player avatars to investigate the objects. It is a further aspect of the present invention that the Game Author may be able to create a worksheet to guide the player's investigation, specifying the objects to be investigated, the properties to be measured and providing data entry forms to input information, provide questions for the player about the observations and conclusions, and provide questions to test the student players understanding of any observations.

In accordance with the present invention, the configurable game has five basic components which allow for customization to suit different learning goals. Teachers, students, and subject matter experts (the Game Author) will be able to customize the game to suit a lesson by selecting from libraries of “Worlds”, “Objects” (or Organisms), and “Instruments”, and using a template to create a “Worksheet” that guides students through a lesson. To create a customized game, the Game Author follows these steps: 1. Choose a World (environment) for the lesson from a library of worlds; 2. Install in this World, Objects chosen from a library that have properties; 3. Select Instruments or capabilities used by a team of students players to determine the Objects' properties; 4. Teams of students, on internet connected computers, travel the World to characterize the Objects; 5. Customize a Worksheet of objectives, data entry, conclusions, and questions to guide the lesson.

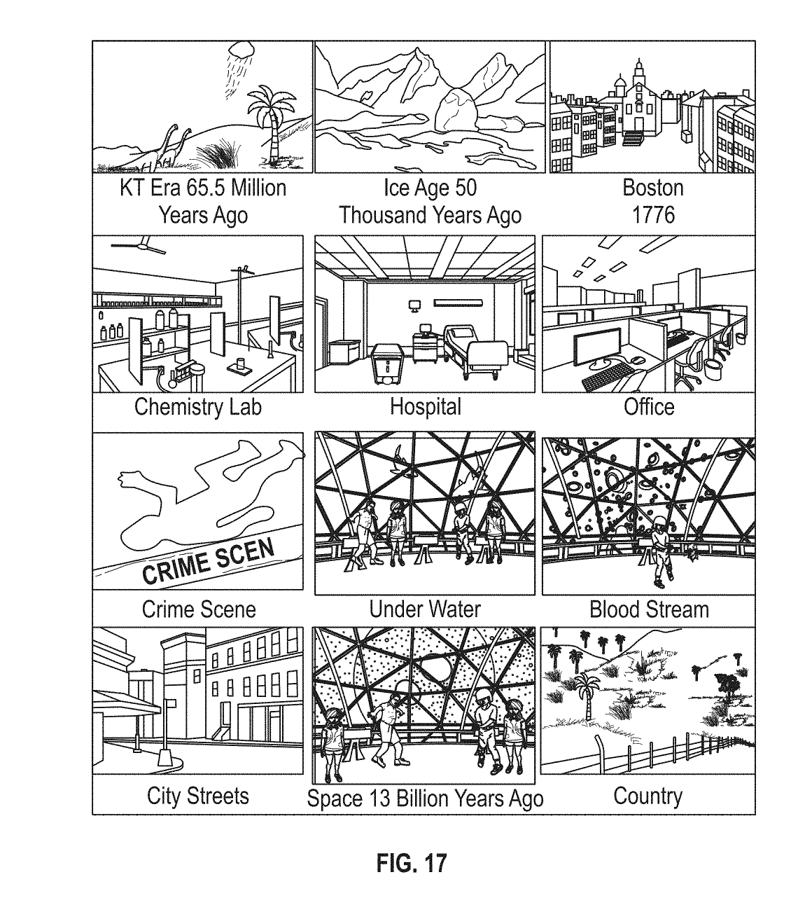

FIG. 17 is an example of a user interface for the selection from a library of World scenes and environments. Each image represents one of the possible Worlds which in a preferred embodiment is a 3-D digital model. Selection of one of the Worlds would result in it being incorporated in the finished Configurable Game.

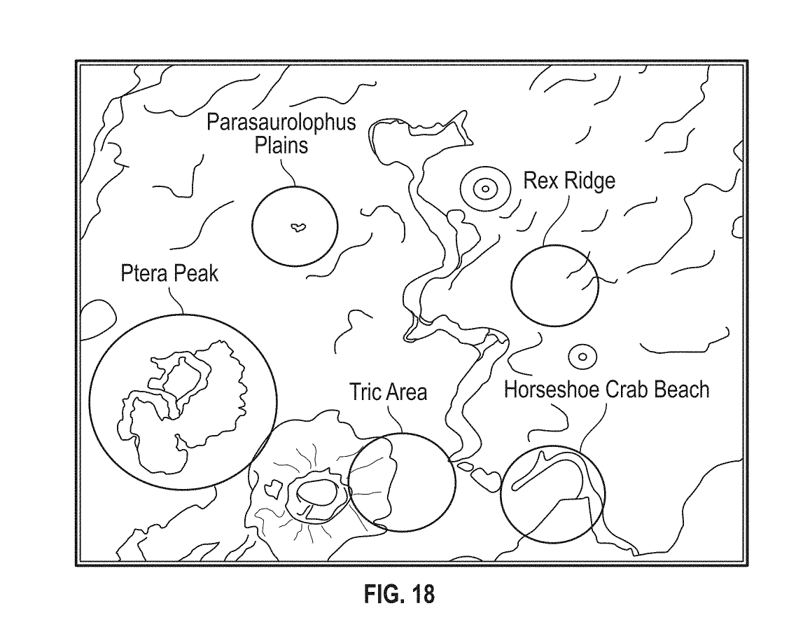

FIG. 18 is an example of a map for a World scene or environment selected from a library showing sectors where objects and organisms may be placed. The division of the World into sectors facilitates the organization of the Configurable Game

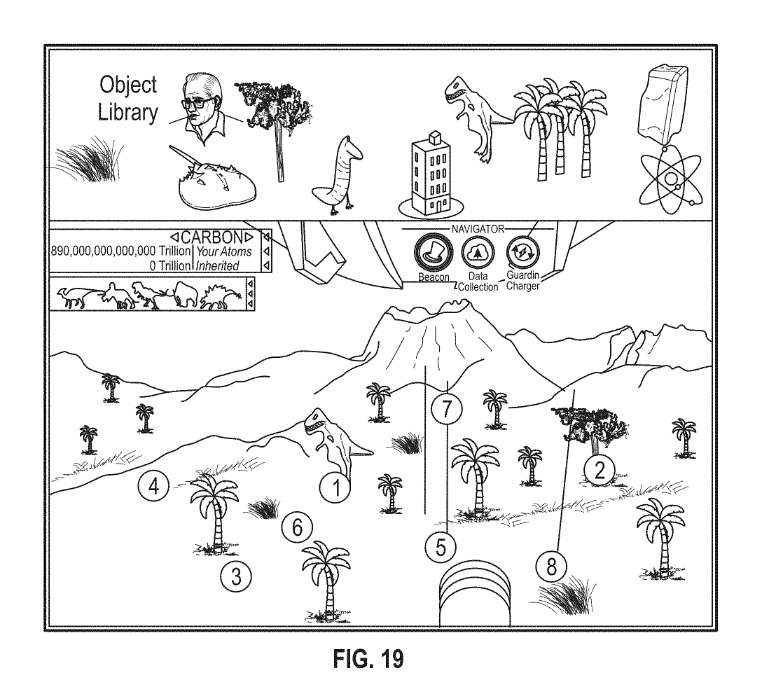

FIG. 19 is an example of the user interface to configure a game by selecting objects and organisms to be located in a sector of a scene or environment. The installing of an object in the game can be facilitated by such an interface in which the Game Author employs a computer display to drag an icon from the library display onto the map in the desired location. The file of actions so developed is then used in constructing the customized game.

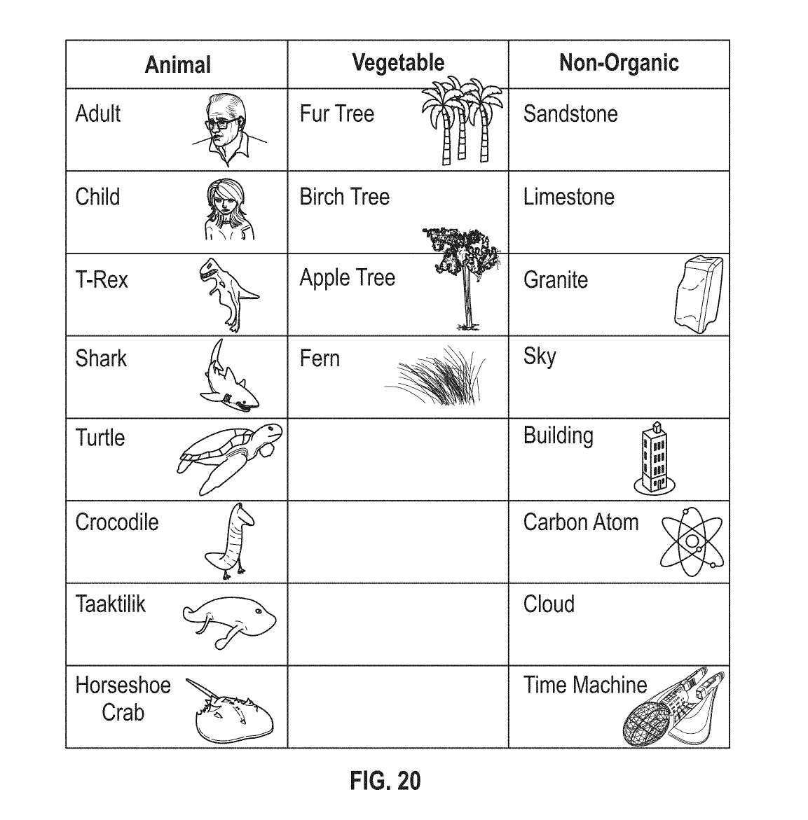

FIG. 20 is an example of a user interface for the library of Objects and Organisms whose properties may be displayed and edited. Using a computer display, the properties for a selected Object may be displayed in detail and edited.

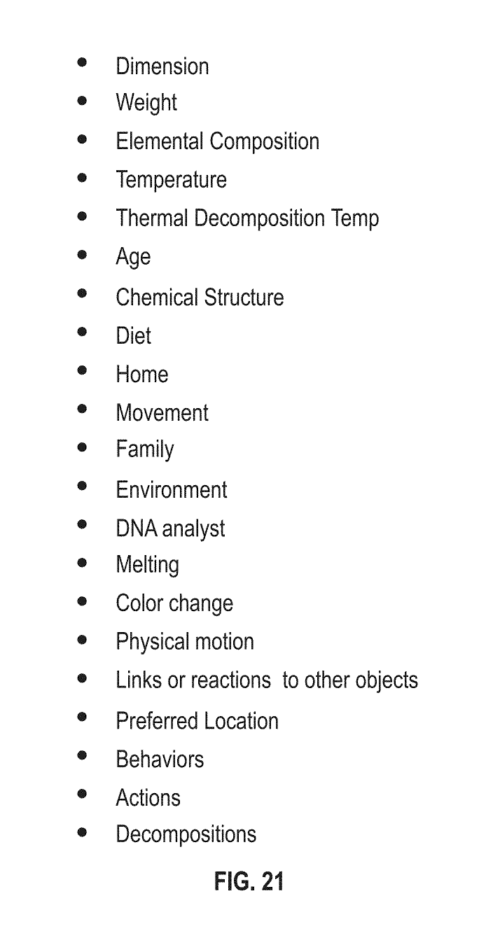

FIG. 21 is an example of Object or Organism properties that may be associated with each Object or Organism. Such a list is only an example and many additional properties can be added.

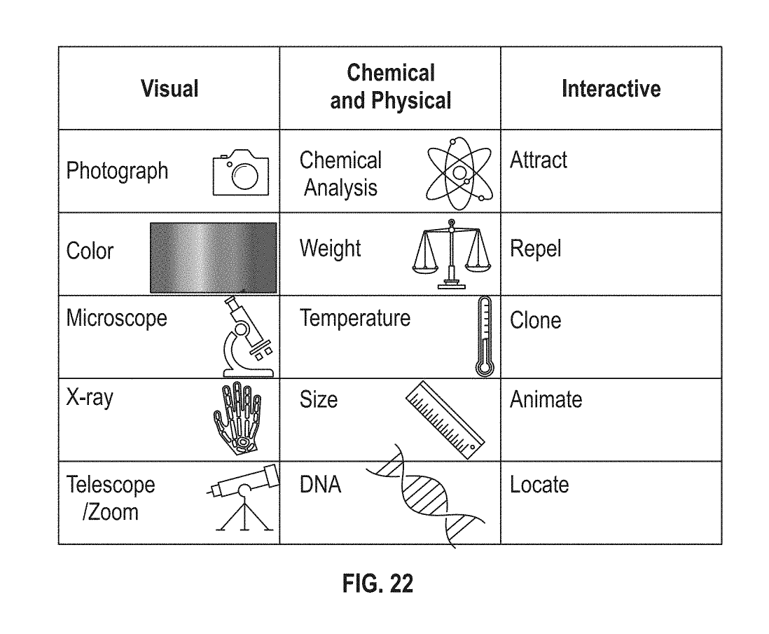

FIG. 22 is an example of a user interface for a library of object or organism properties to be measured or activated by the virtual instruments or capabilities. Using a computer display, the properties measured by a selected instrument or capability may be displayed in detail and edited.

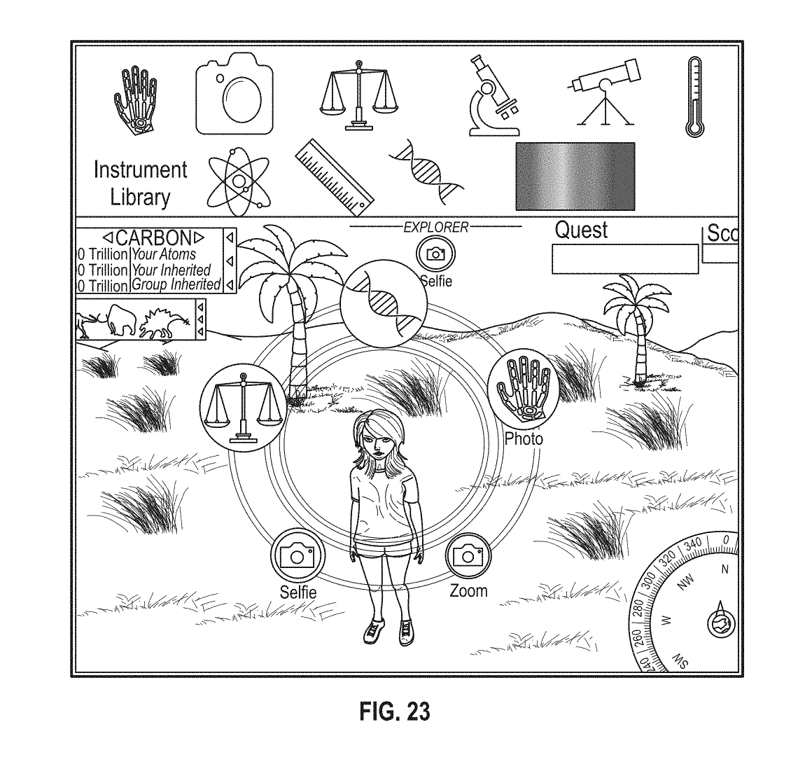

FIG. 23 is an example of a user interface for selecting instruments and capabilities assigned to and used by one of the game player's avatars. The installing of an instrument or capability in the game for a given player roll can be facilitated by such an interface in which the Game Author employs a computer display to drag an icon from the library display a capabilities display for that given player. The file of actions so developed is then used in constructing the customized game.

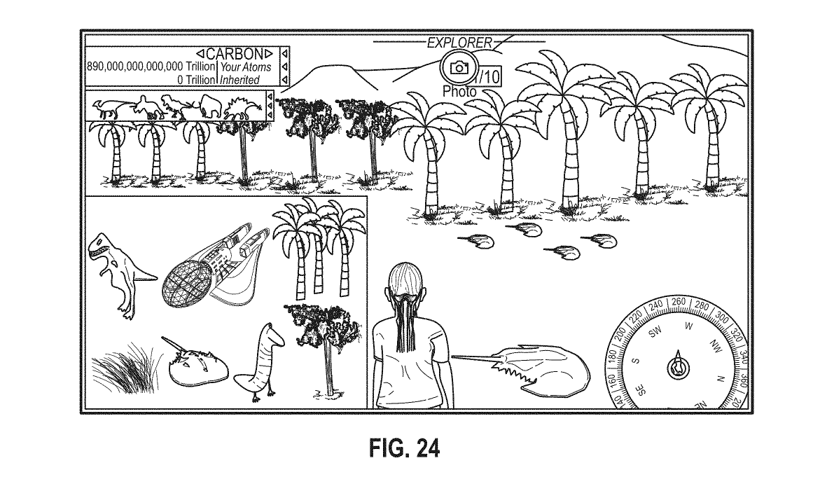

FIG. 24 is an illustration of preferred embodiment of the technology called an In-Game Editor. Such an editor is created within the game itself. The illustration is for selecting objects or organisms to be placed in a scene or environment. In this illustration, the Game Author plays the game in the selected World using any player Avatar. That avatar can move about the World. A part of the user interface is a library of objects that can be used in the game. Such a library could be preselected from the complete library based on the objectives of the game. For example a game about the KT extinction era might have the Game Author select from the complete library, only the dinosaurs, other animals, and plants that were alive in that era, and perhaps a few additional objects such as skeletons and rocks. At any place in the player may use a grab function to take hold of one of the objects in the object display and place it where desired in the World.

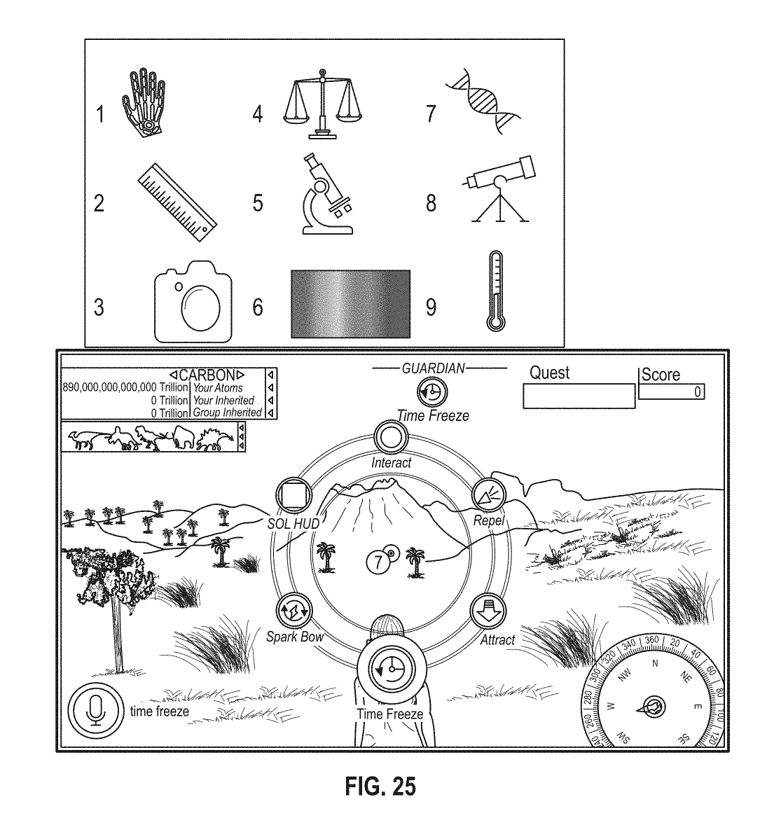

FIG. 25 is an illustration of an In-Game Editor for selecting the instruments or capabilities available to each player Avatar. For this selection, the Game Author plays the role of the avatar which is to receive the instrument or capability. The Game Author brings up the player's selection wheel which is used in game play to select an instrument or capability. Then placing the players cursor on a place on the wheel, the Game Author types the number of the capability or instrument to be assigned to that place. A reminder of the number can be obtained using the Tab key which brings up the summary shown at the top of the diagram. This action leads to the assigned instrument or capability being available to the player with that role during game play.

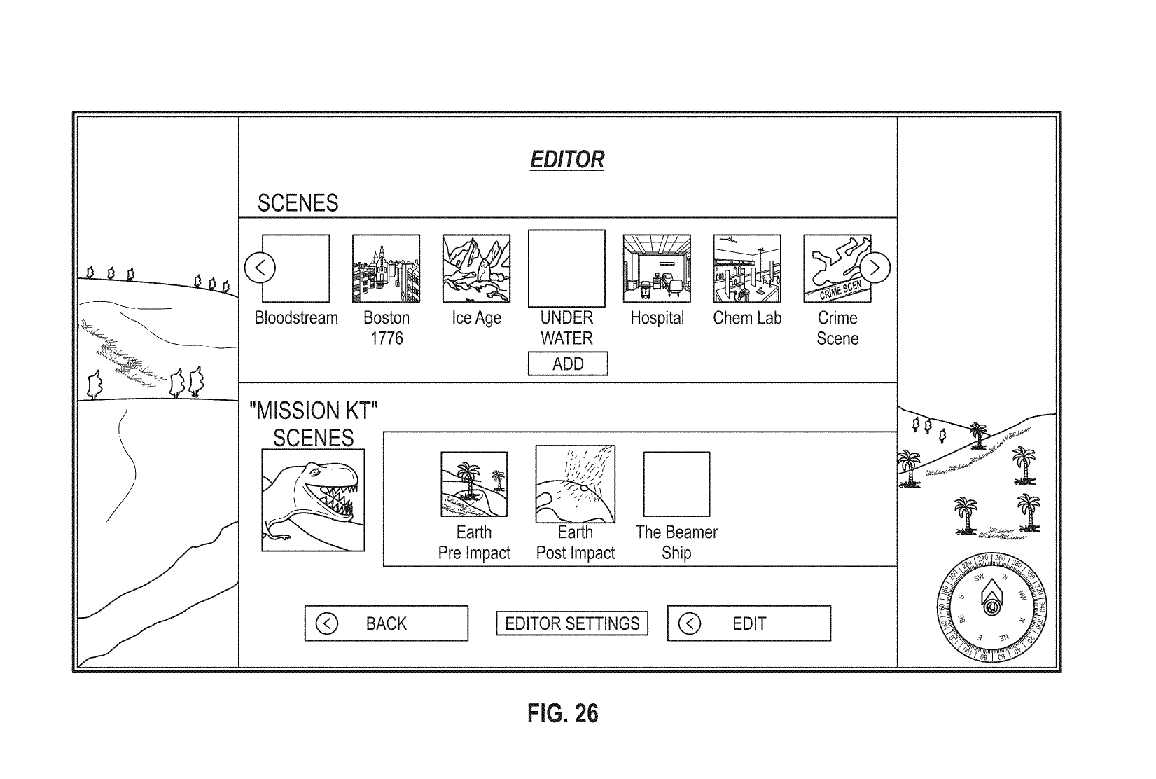

FIG. 26 is an illustration of an In-Game Editor for selecting multiple scenes which can be linked to produce the configurable game. It should be recognized that this is only an example of the many ways in which the selection of multiple scenes can be accomplished. In this embodiment, all the scenes available in the library are represented on the top row. The user may scroll through the list and identify by a mouse, touch screen, game controller, voice or other method, which scenes are to be used in the game which is being configured. The selected scenes are then displayed on the lower portion of the screen together with the name and icon selected for game being configured. In this case the lower portion shows scenes for the Game Mission KT.

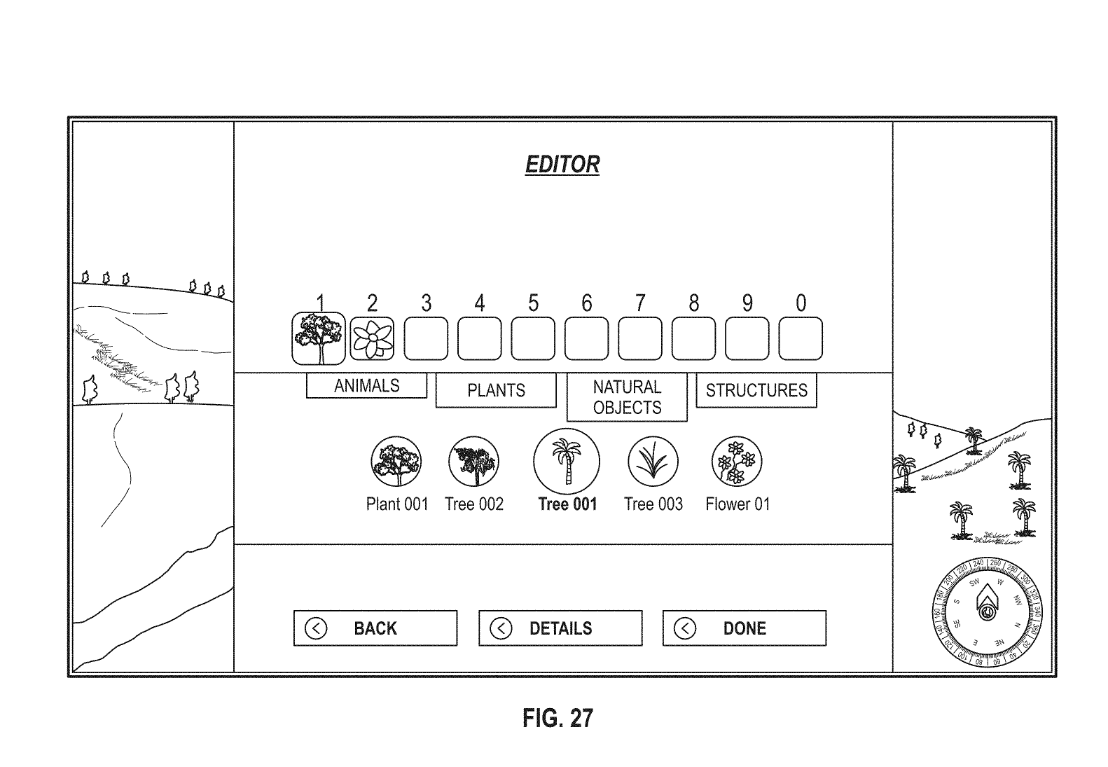

FIG. 27 is an illustration of an In-Game Editor used for selecting multiple objects or organisms to be placed in the game scenes. Again, it should be recognized that this is only an example of the many ways in which the selection of multiple scenes can be accomplished. In this user interface, the user selects the category of objects/organisms from among plants, animals, natural objects, and structures. In the illustration, the category natural objects is used for natural things such as rocks, earth, clouds, puddles, etc., while structures is used for man-made objects such as bridges, buildings, cars, etc. The available objects in that category are scrolled across the middle portion of the screen. The desired object is selected by mouse, touch screen, game controller or other method and a number from 1, 2 . . . to 9, 0 is assigned to the object by selecting that number on a key board. The object then appears in the upper part of the screen in the box for that number. To place objects in a scene, the Author of the game selects the scene and the category of objects, and using an avatar, enters the scene. Then as the avatar wanders the scene, an object of the selected category may be placed at the avatar's location by typing the number from a keyboard. This process is then repeated with all the other desired categories of objects or organisms. Many variations on this scheme could be created by those skilled in the art.

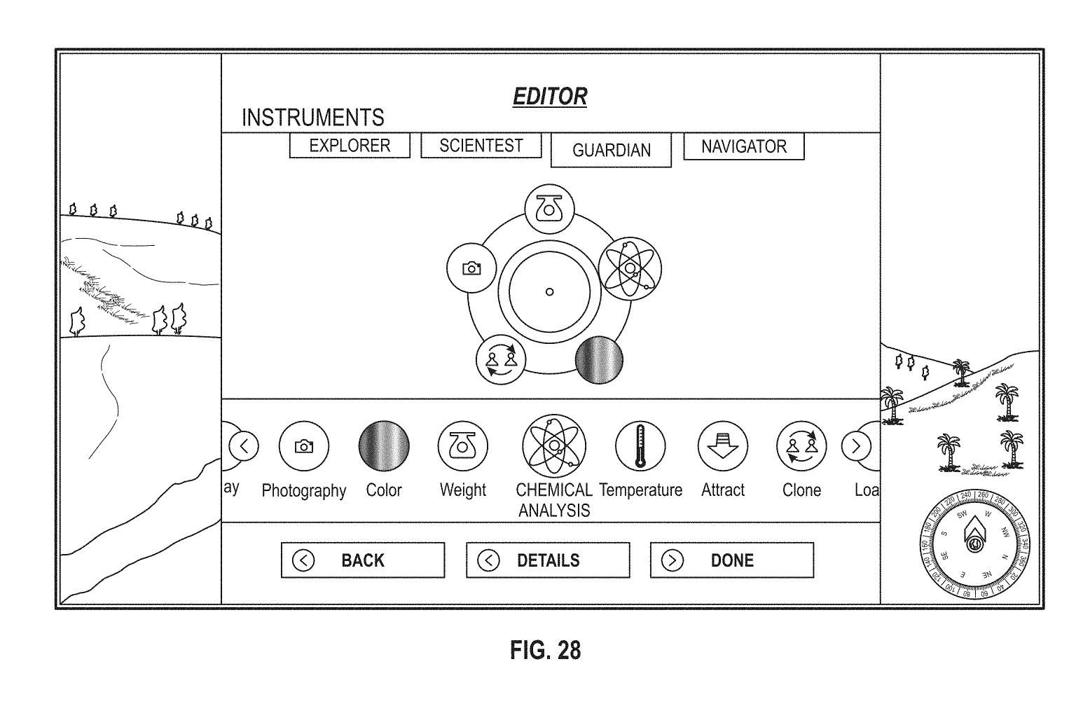

FIG. 28 is an illustration of an In-Game Editor used for selecting multiple tools, virtual instruments or capabilities to assign to any one of players functions. Example player functions are listed at the top (Explorer, Scientist, Guardian, Navigator). Once a player function is selected, one of the positions on that players tool wheel is selected by mouse, game controller, touch screen, voice or other method. Then the tools may be scrolled until the desired tool appears in the center of the screen. Touching of the place on the wheel again will assign that tool to the place in the wheel. During the game, the tool selection wheel is employed by the player playing that function to use in analyzing an object or organism. This process is repeated for as many separate player functions as will appear in the game. This illustration shows four choices however the number of player functions and their names and assignments may be modified to suite the customized game.

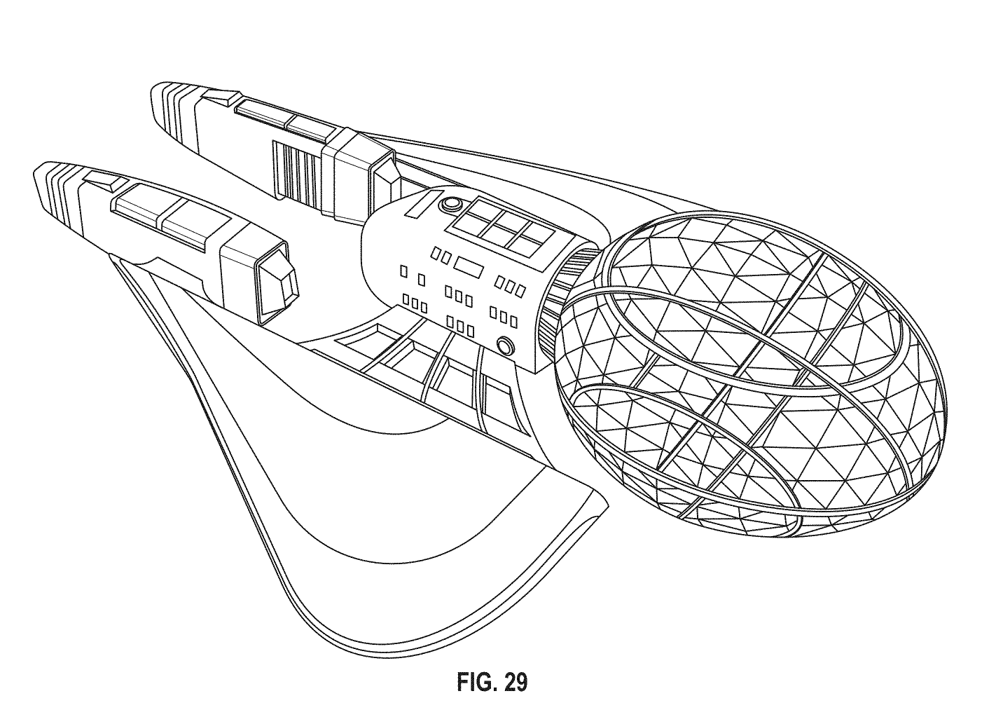

FIG. 29 is an illustration of a different preferred embodiment of the invention in which a time, space and size-change travel machine called the Cosmic Egg is employed both as an In-Game Editor to configure the custom game and as a feature of the game which links scenes of different places, dates in history, and scene dimension changes from microscopic to cosmic sizes. The illustration shows the exterior of the Cosmic Egg in a space scene. The Cosmic Egg or any equivalent concepts presents a convenient transition for changing scenes when a scene change represents a change in location, time, or size.

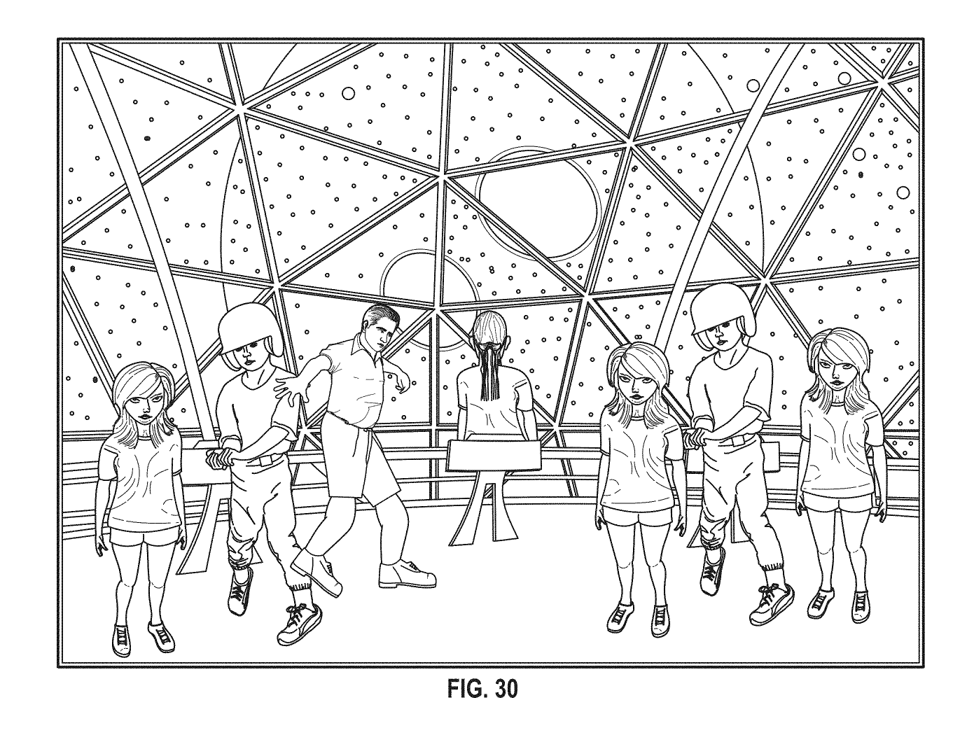

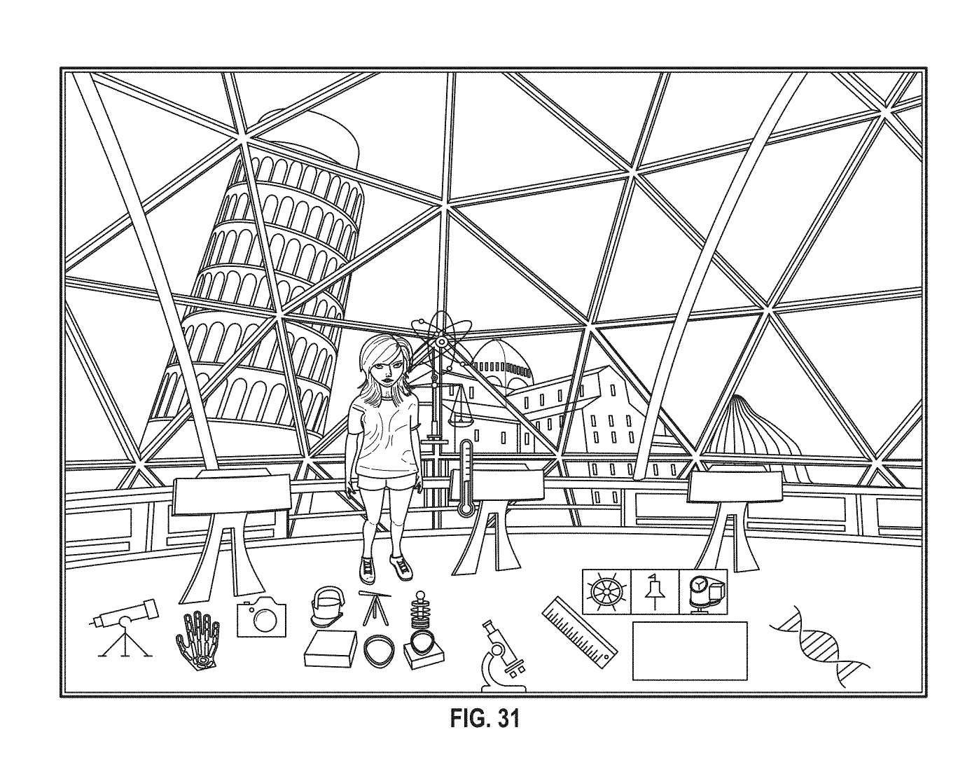

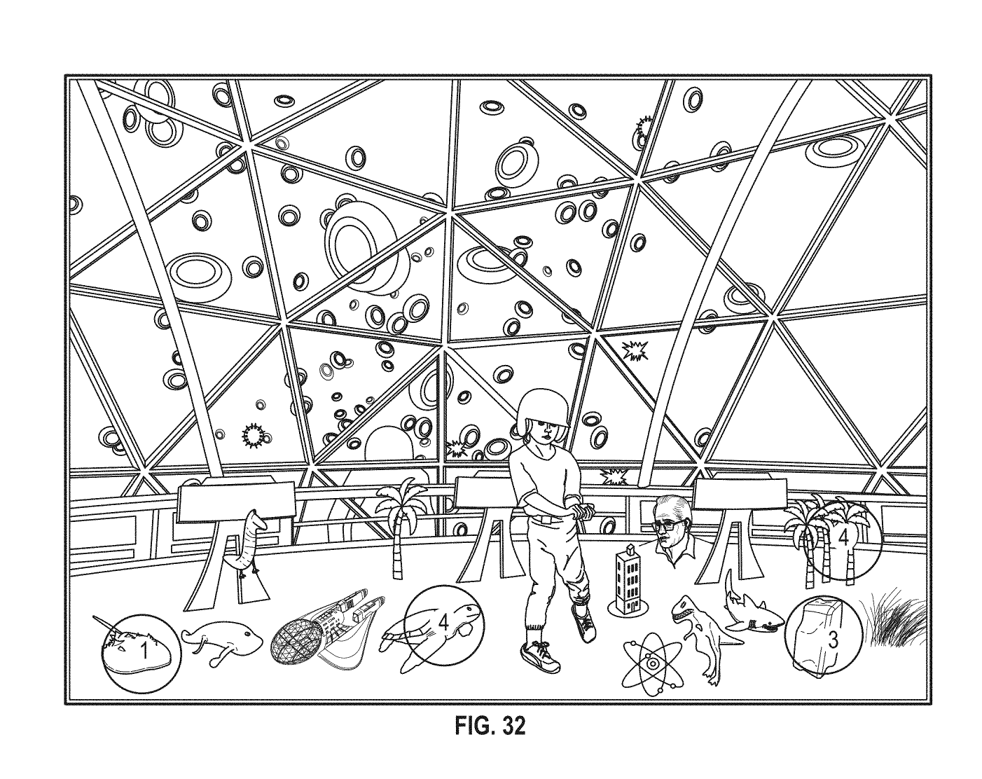

FIG. 30 is an illustration of an alternative preferred embodiment of the invention's in-game editor presenting the use of an interactive game scene rather than the kind of user interface editor illustrated in FIGS. 26-28. FIG. 30 illustrates the interior of the Cosmic Egg used as an In-Game Editor for the display and selection of the avatars used by the players in the completed game. The illustration shows the view from the Cosmic Egg flight deck of a space scene illustrating two black holes. The flight deck of the Cosmic Egg is employed as an In-Game Editor. It has a wide selection of avatars standing on the deck which may be chosen for use with the different player functions. The Author, as an avatar, is present in the scene and able to move about. The Author selects the player functions such as those shown as examples in FIG. 28 (Explorer, Scientist, Guardian and Navigator). The Author's avatar may then move about the flight deck and choose an avatars for each function. The Author may also select alternative avatars to include in the game to be selected by the players. The selection is complete when all the player avatars filling the player rolls and the alternatives have been selected. Other rooms of the Cosmic Egg or other parts of the flight deck itself (as shown in FIGS. 31 and 32) may be similarly employed for the selection of the objects/organisms and player tools/instruments to be used in the game. It should be realized that the editing function described above could be performed in any scene or alternatively using an appropriate user interface as illustrated in FIGS. 26-28.

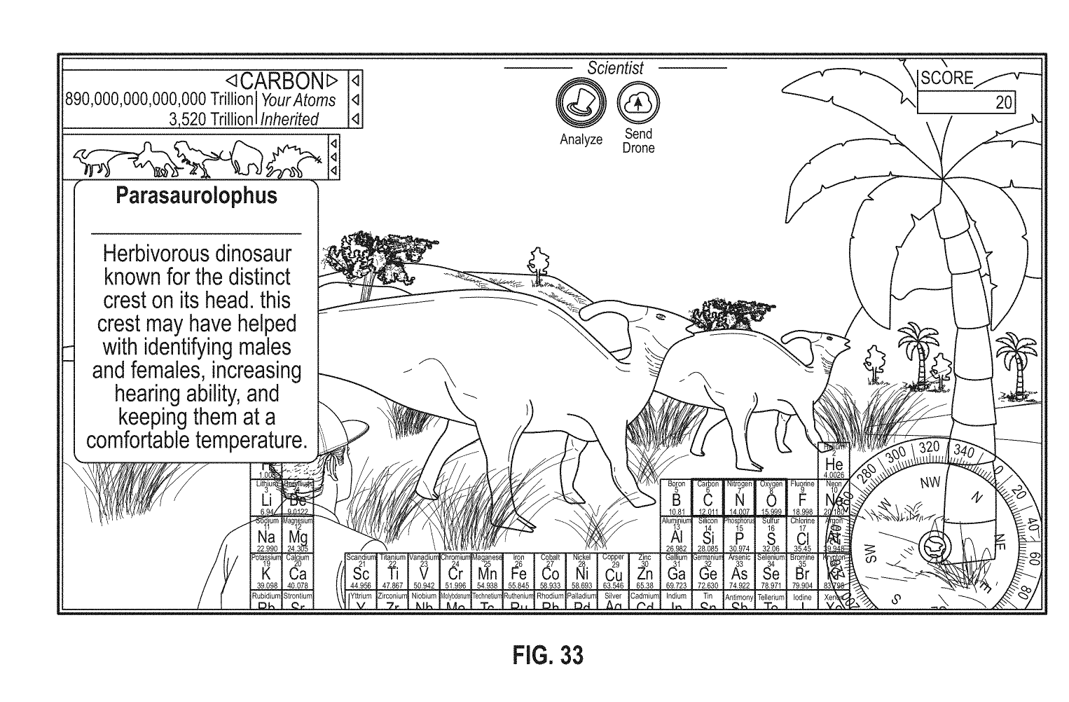

FIG. 31 is an illustration of an alternative preferred embodiment of the invention presenting the Interior of the Cosmic Egg used as an In-Game Editor for the display and selection of the tools or virtual instruments to be employed in the completed game. As in the case of the player function and player avatar selection illustrated in FIG. 31, the Author's avatar may move about the flight deck and select the tools that are desired for each of the player functions selected for the game. In this case, the Author selects the player function to be used in the game that was previously chosen (for example in FIG. 30). Then, moving about the flight deck or special tool room, the Author's avatar selects the set of tools which it will use by that player function in the game. The selection of tools fills that players selection wheel (see FIGS. 23 and 28). In the game, the selection wheel appears on command (using a keyboard key or controller button) for the player as shown in FIG. 23, to choose the tool or capability which the player wishes to apply to an object. The application of the tool to the object results in information on that object presented to the player such as the elemental composition of the object as shown in FIG. 33. As in the case of the selection of player functions, the selection of tools could be performed in any scene or alternatively using an appropriate non-game play user interface such as in FIG. 28.

FIG. 32 is an illustration of an alternative preferred embodiment of the invention presenting the Interior of the Cosmic Egg used as an In-Game Editor for the display and selection of the of the objects and organisms that are to be placed in the completed game. Any room in the Cosmic Egg, any scene in the game, or a special scene such as a curio shop may be equivalently used. As in the case of the player avatar selection, the author's Avatar may move about the flight deck and select the objects or organisms that are desired for the game. Objects selected are given numbers 1, 2 . . . 9, 0. When the selection is complete, the Author chooses a scene in which to place the objects or organisms, enters the scene as an avatar, and types the number of the desired object while the Author's avatar is standing in the location desired for that object or organism. FIG. 19 illustrates the placing of objects in a game scene using numbers. The selection method illustrated by FIG. 19, is an alternative to the one illustrated by FIG. 27. The different types of things which may be selected, shown as the categories animals, plants, natural objects and structures, in FIG. 27 may be placed in separate rooms or separate locations on the flight deck. As for the selection of tools shown in FIG. 31, the selection of objects could be performed in any scene or alternatively using an appropriate user interface such as in FIG. 27.

FIG. 33 is an illustration of a preferred embodiment of the invention presenting the player's user interface resulting from a player using the “Analysis” tool on a dinosaur target to determine its elemental composition. The major elements in the object are displayed as the blue colored elements in the periodic table. Additional data on the dinosaur is also provided. The percent of each element can be additionally displayed as can the minor elements in the dinosaur target. The analysis is performed by locating the target object by, for example, a cross hair, arrow, mouse or other position selection method and pressing a keyboard key or controller button.

Although this invention has been shown and described with respect to detailed embodiments thereof, it will be understood by those skilled in the art that various changes in form and detail thereof may be made without departing from the spirit and the scope of the invention. With respect to the embodiments of the systems described herein, it will be understood by those skilled in the art that one or more system components may be added, omitted or modified without departing from the spirit and the scope of the invention. With respect to the embodiments of the methods described herein, it will be understood by those skilled in the art that one or more steps may be omitted, modified or performed in a different order and that additional steps may be added without departing from the spirit and the scope of the invention.

In accordance with another aspect of the invention, provided is a computer-implemented method for providing digital games and lessons utilizing virtual measurement instruments and virtual objects. In one embodiment, the method comprises executing with one or more physical computer processors a plurality of components, including an environment component, an instrument component, and an object component. Executing the environment component to present an instance of a computer game to one or more users via one or more user computer devices. The computer game comprises a virtual scene, a plurality of virtual objects, and a plurality of virtual measurement instruments. Also, the computer game comprises an interface for user inputs for controlling in-game actions, including selection of virtual objects and virtual measurement instruments. Executing the instrument component to store a library of the virtual measurement instruments available in the computer game. And further executing the instrument component to graphically present, to the user via the user computer device, a user-selected virtual measurement instrument. Executing the object component to store a database of the virtual objects available in the computer game and data regarding various properties of the virtual objects. And further executing the object component to graphically present, to the user via the user computer device, data associated with a user-selected property of a virtual object and the user selected virtual measurement instrument.

In some embodiments, the method further comprises executing a lesson component to graphically present, to the user via the user computer device, a player objective sequence that indicates a set of virtual objects to be analyzed by the user using one or more virtual measurement instruments. Further, in some embodiments, the method further comprises executing the lesson component to graphically present, to the user via the user computer device, a worksheet providing tables for the user to enter data and prompts to the user to answer questions regarding the player objective sequence.

Additionally, in some embodiments, the method further comprises executing a software application on a secondary computer device in communication with the one or more processors for simulating and displaying the user selected virtual measurement instrument on the secondary computer device. And further executing the software application on the secondary computer device to communicate with the instrument component so that use of the measurement instrument presented on the secondary computer device is coordinated with the play of the computer game on the user computer device.

In another embodiment, the method comprises presenting a computer game to one or more users via one or more user computer devices, where the computer game includes a virtual scene, a plurality of virtual objects, and a plurality of virtual measurement instruments. The method also comprises presenting to the user(s) a player objective sequence that indicates a set of virtual objects to be analyzed by the user using one or more virtual measurement instruments. The method further comprises receiving user(s) input for a selected instrument, a selected object, and a selected object property, and presenting to the user(s) data corresponding to the selected instrument, object, and object property. The method additionally may comprise presenting to the user(s) a worksheet providing tables for the user(s) to enter data and prompts to the user(s) to answer questions regarding the player objective sequence.

Additionally in some embodiments of the method, the one or more computing devices provides an interface for a teacher or other facilitator of the lesson with templates to facilitate the creation of one or more customized lesson comprising the player objective sequences to be displayed for the player and the worksheets for the player to record data and answer questions.

In accordance with another aspect of the invention, provided is a non-digital game for providing lessons regarding the measurement of objects' properties using different measurement instruments. The game comprises a set of physical representations of a plurality of scenes, a set of physical representations of a plurality of objects, a reference book listing various properties of the plurality of objects, and a plurality of worksheet templates. The physical representations of the scenes may be photographs, illustrations, dioramas, etc., which depict different environments and/or time periods. The physical representations of the objects may be figurines, miniature objects, photographs, illustrations, stickers, etc., which can be placed in association with a physical representation of a scene. Each object has a unique identifier that is visually presented thereon. The reference book lists the unique identifiers corresponding to the plurality of objects and various properties for each of the objects. The worksheet is configured to provide a player objective sequence that indicates a set of objects to be analyzed, prompts for the player to record data regarding the objects found in the reference book, and prompts for the player to answer questions regarding the objects found in the reference book.

In accordance with another aspect of the invention, provided is a method of using a non-digital game for providing lessons regarding the measurement of objects' properties using different measurement instruments. The method comprises providing a physical representation of a scene, a plurality of physical representations of different objects in association with the physical representation of the scene, a reference book listing various properties of the objects, and a worksheet. Presenting a user with the worksheet, where the worksheet provides a player objective sequence that indicates a set of objects to be analyzed, prompts for the player to record data regarding properties of the objects found in the reference book, and prompts for the player to answer questions regarding the properties of the objects found in the reference book.

Additionally in some embodiments of the method, additional material is provided for a teacher or other facilitator of the lesson including templates to facilitate the creation of one or more customized lesson comprising the player objective sequences to be available for the player and the worksheets for the player to record data and answer questions.

1. A computer system for providing digital games and lessons utilizing virtual measurement instruments and virtual objects, comprising:
one or more physical computer processors executing a plurality of components, including an environment component, an instrument component, and an object component;
wherein the environment component executes an instance of a computer game to one or more users via one or more user computer devices;
wherein the computer game comprises a virtual scene, a plurality of virtual objects, and a plurality of virtual measurement instruments;
wherein the computer game comprises an interface for user inputs for controlling in-game actions, including selection of virtual objects and virtual measurement instruments;
wherein the instrument component comprises a library of the virtual measurement instruments available in the computer game, and graphically presents, to the user via the user computer device, a user-selected virtual measurement instrument; and
wherein the object component comprises a database of the virtual objects available in the computer game and data regarding various properties of the virtual objects, and graphically presents, to the user via the user computer device, data associated with a user-selected property of a virtual object and the user selected virtual measurement instrument.

2. The computer system according to claim 1, wherein the one or more processors of the system further execute a lesson component that graphically presents, to the user via the user computer device, a player objective sequence that indicates a set of virtual objects to be analyzed by the user using one or more virtual measurement instruments.

3. The computer system according to claim 1, wherein the lesson component graphically presents, to the user via the user computer device, a worksheet providing tables for the user to enter data and prompts to the user to answer questions regarding the player objective sequence.

4. The computer system according to claim 1, further comprising a secondary computer device in communication with the one or more processors;
wherein the secondary computer device executes a software application for simulating and displaying the user selected virtual measurement instrument on the secondary computer device.

5. The computer system according to claim 4, wherein the secondary computer device executes the software application and communicates with the instrument component so that use of the measurement instrument presented on the secondary computer device is coordinated with the play of the computer game on the user computer device.

6. A computer-implemented method for providing digital games and lessons utilizing virtual measurement instruments and virtual objects, comprising the steps of:
executing with one or more physical computer processors a plurality of components, including an environment component, an instrument component, and an object component;
executing the environment component to present an instance of a computer game to one or more users via one or more user computer devices;
wherein the computer game comprises a virtual scene, a plurality of virtual objects, and a plurality of virtual measurement instruments;
wherein the computer game comprises an interface for user inputs for controlling in-game actions, including selection of virtual objects and virtual measurement instruments. Executing the instrument component to store a library of the virtual measurement instruments available in the computer game;
executing the instrument component to graphically present, to the user via the user computer device, a user-selected virtual measurement instrument;
executing the object component to store a database of the virtual objects available in the computer game and data regarding various properties of the virtual objects; and
executing the object component to graphically present, to the user via the user computer device, data associated with a user-selected property of a virtual object and the user selected virtual measurement instrument.

7. The method according to claim 6, further comprising the step of: executing a lesson component to graphically present, to the user via the user computer device, a player objective sequence that indicates a set of virtual objects to be analyzed by the user using one or more virtual measurement instruments.

8. The method according to claim 7, further comprising the step of: executing the lesson component to graphically present, to the user via the user computer device, a worksheet providing tables for the user to enter data and prompts to the user to answer questions regarding the player objective sequence.

9. The method according to claim 6, further comprising the step of: executing a software application on a secondary computer device in communication with the one or more processors for simulating and displaying the user selected virtual measurement instrument on the secondary computer device.

10. The method according to claim 9, further comprising the step of: executing the software application on the secondary computer device to communicate with the instrument component so that use of the measurement instrument presented on the secondary computer device is coordinated with the play of the computer game on the user computer device.

11. The method according to claim 6, further comprising the step of: receiving user(s) input for a selected instrument, a selected object, and a selected object property, and presenting to the user(s) data corresponding to the selected instrument, object, and object property.

12. A computer-implemented method for providing customized digital games and lessons utilizing virtual measurement instruments and virtual objects, comprising the steps of:
executing with one or more physical computer processors an In-Game Editor component to generate an In-Game Editor Graphical User Interface (GUI) on a user computer device;
wherein the In-Game Editor GUI includes:
a virtual scene;
a library of different virtual environments;
a library of different virtual objects; and
a library of different virtual instruments;
wherein the In-Game Editor GUI is configured to receive user inputs to define a customized game, including:
selection of one or more virtual environments;
selection and placement of one or more virtual objects in the selected virtual environments; and
selection of one or more virtual instruments associated with the selected virtual objects;
storing the selection of virtual environments, selection and placement of virtual objects in the selected virtual environments and selection of virtual instruments associated with the selected virtual objects for the customized game.

13. The computer-implemented method according to claim 12, wherein the In-Game Editor GUI includes one or more avatars configured to be controlled by user inputs to make selections from the library of different virtual environments, library of different virtual objects, and library of different virtual instruments.

14. The computer-implemented method according to claim 13, wherein the In-Game Editor GUI is configured to receive user inputs for selecting one of the one or more avatars in the virtual scene to define a customized game for the selected avatar.

15. The computer-implemented method according to claim 14, further comprising the step of: storing the selection of virtual environments, selection and placement of virtual objects in the selected virtual environments and selection of virtual instruments associated with the selected virtual objects for the customized game for the selected avatar.

16. The computer-implemented method according to claim 12, further comprising the step of: executing with the one or more physical computer processors a lesson component to graphically present a player objective sequence for the customized game that indicates the selected virtual environments to be explored, the selected virtual objects to be analyzed in the selected virtual environments, and the selected virtual instruments to be used to analyze the selected virtual objects.

17. The computer-implemented method according to claim 12, further comprising the step of: executing with the one or more physical computer processors an environment component to provide the selected virtual environments in the customized game.

18. The computer-implemented method according to claim 12, further comprising the step of: executing with the one or more physical computer processors an object component to provide the selected virtual objects in the customized game.

19. The computer-implemented method according to claim 12, further comprising the step of: executing with the one or more physical computer processors an instrument component to provide the selected virtual instruments in the customized game.

20. The computer-implemented method according to claim 12, wherein the In-Game Editor GUI includes a template for creating a worksheet providing tables for entering data and answering questions regarding a player objective sequence; and further comprising the step of: receiving user inputs in the template for creating the worksheet.
